(19) United States
(12) Patent Application Publication
(10) Pub. No.: US 2026/0168797 A1
(43) Pub. Date: Jun. 18, 2026

(54) SYSTEM AND METHOD FOR AVOIDING HAZARDOUS ATMOSPHERIC ZONES

(71) Applicant: WindBorne Systems Inc., Palo Alto, CA (US)

(72) Inventors: Valerie Hau, San Jose, CA (US); Andrey Sushko, Sunnyvale, CA (US); John Lars Anderson Dean, Palo Alto, CA (US); Joan Creus Costa, Redwood City, CA (US); Kai Marshland, Palo Alto, CA (US)

(21) Appl. No.: 19/418,478

(22) Filed: Dec. 12, 2025

Related U.S. Application Data
(60) Provisional application No. 63/733,204, filed on Dec. 12, 2024.

(51) Int. Cl. G01C 21/20; B64B 1/40; B64B 1/70; G01W 1/10; G08G 5/76

(52) U.S. Cl. CPC G01C 21/20; B64B 1/40; B64B 1/70; G01W 1/10; G08G 5/76

(57) ABSTRACT

One variation of a method includes, at a remote computer system: receiving a set of ambient data collected by an aerial vehicle traversing an oscillating flight path; predicting a hazardous-risk zone, proximal the oscillating flight path of the aerial vehicle, during a future time window based on the set of ambient data; defining an altitude band constraining the oscillating flight path of the aerial vehicle during the future time window; defining an alternative minimum altitude, within the altitude band, proximal a the hazardous-risk zone; and transmitting the altitude band and the alternative minimum altitude to the aerial vehicle. This variation of the method also includes, at the aerial vehicle, in response to detecting a hazardous atmospheric condition proximal the aerial vehicle following descent of the aerial vehicle below the alternative minimum altitude, triggering an actuator in the aerial vehicle to transition from descent to ascent.

### CROSS-REFERENCE TO RELATED APPLICATIONS

This Application claims the benefit of U.S. Provisional Application No. 63/733,204, filed on 12 Dec. 2024, which is incorporated in its entirety by this reference.

This Application is related to U.S. Non-Provisional Application No. Ser. No. 18/780,159, filed on 22 Jul. 2024, which is hereby incorporated in its entirety by this reference.

### TECHNICAL FIELD

This invention relates generally to the field of radiosonde meteorology and, more specifically, to a new and useful system and method for avoiding hazardous atmospheric zones in the field of radiosonde meteorology.

### BRIEF DESCRIPTION OF THE FIGURES

FIGS. 1A and 1B are flowchart representations of a method;

FIGS. 2A and 2B are flowchart representations of one variation of the method;

FIGS. 3A and 3B are flowchart representations of one variation of the method;

FIG. 4 is a flowchart representation of one variation of the method;

FIG. 5 is a flowchart representation of one variation of the method;

FIG. 6 is a schematic representation of a system; and

FIG. 7 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

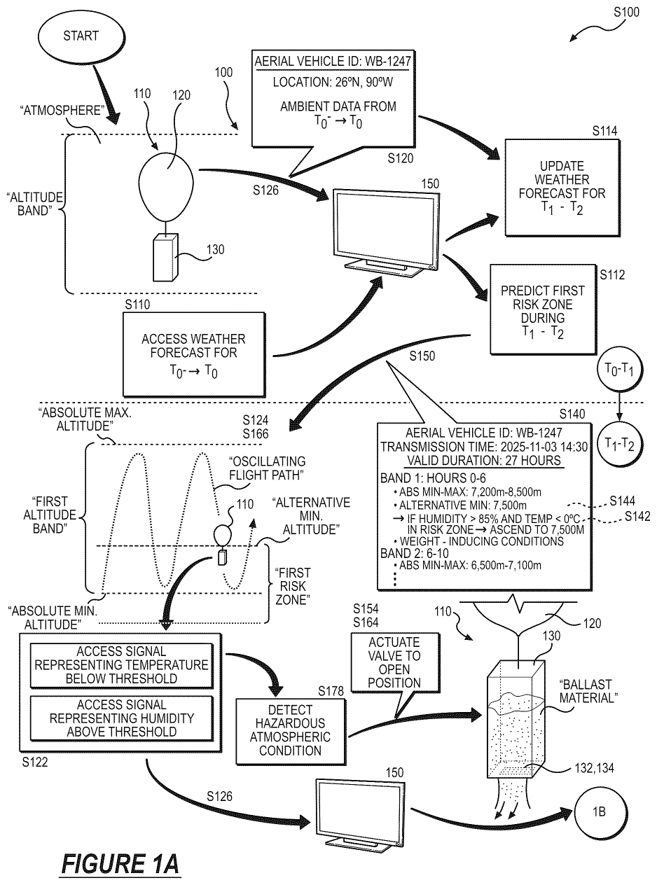

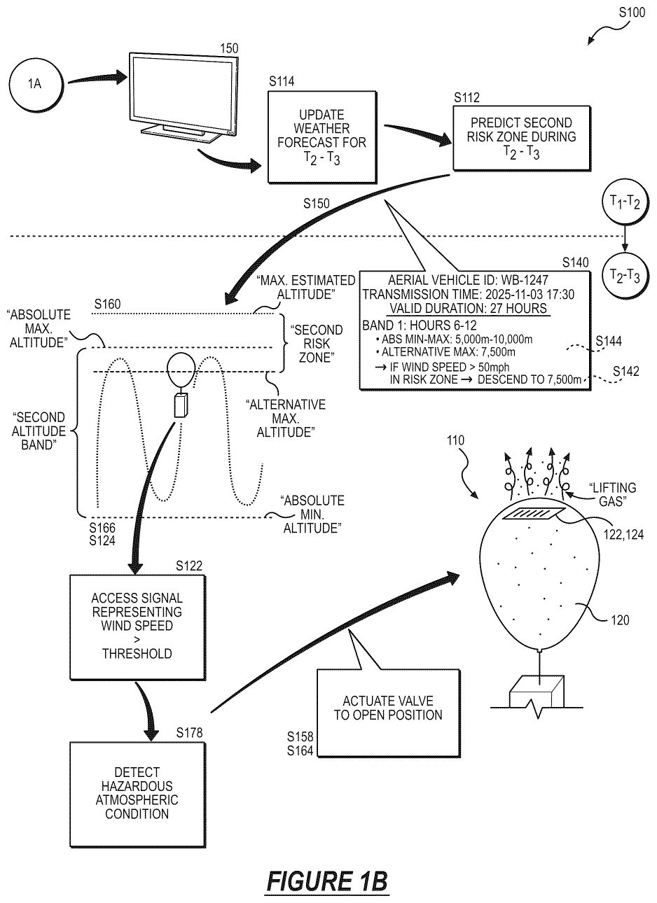

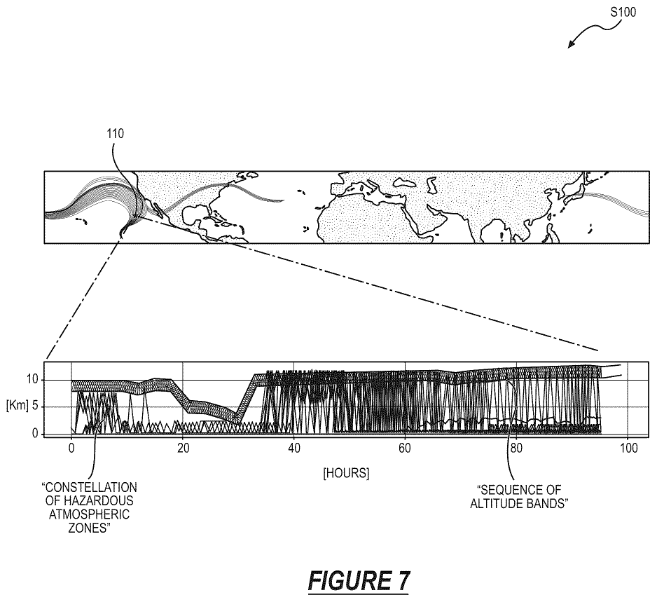

As shown in FIGS. 1A, 1B, 2A, 2B, 3A, 3B, and 7, a method S100 includes, at a remote computer system 150, at a first time: receiving an initial geospatial location of an aerial vehicle 110, traversing an oscillating flight path, at an initial time preceding the first time; receiving an initial set of ambient data, recorded over an initial time window preceding the first time, from the aerial vehicle 110 in Block S120; and updating a first weather forecast for a first forecast window succeeding the first time based on the initial set of ambient data in Block S114.

The method S100 also includes, at the remote computer system 150, based on the first weather forecast: predicting a first hazardous-risk zone, proximal the oscillating flight path of the aerial vehicle 110, during the first forecast window in Block S112; defining a first altitude band constraining the oscillating flight path of the aerial vehicle 110 during a first time window succeeding the initial time window in Block S140, the first altitude band defining a first absolute minimum altitude intersecting the first hazardous-risk zone and a first absolute maximum altitude; and defining a first alternative minimum altitude, between the first absolute minimum altitude and the first absolute maximum altitude, proximal a first boundary of the first hazardous-risk zone for the first time window in Block S144. The method S100 further includes, at the remote computer system 150, transmitting the first altitude band and the first alternative minimum altitude to the aerial vehicle 110 in Block S150.

The method S100 also includes, at the aerial vehicle 110: accessing a first set of signals output by a suite of sensors 160 arranged on the aerial vehicle 110 while descending toward the first alternative minimum altitude during the first time window in Block S122; based on the first set of signals, detecting a first hazardous atmospheric condition proximal the aerial vehicle 110 in Block S178; and, in response to detecting the first hazardous atmospheric condition following descent of the aerial vehicle 110 below the first alternative minimum altitude, triggering a ballast actuator 134 in the aerial vehicle 110 to increase net buoyancy of the aerial vehicle 110 to transition the aerial vehicle 110 from descent to ascent in Block S154.

### 1.1 Variation: Alternative Maximum Altitude+Descending Escape

As shown in FIGS. 1A, 1B, 2A, 2B, 3A, and 3B, one variation of the method S100 includes, at a remote computer system 150: receiving an initial set of ambient data, recorded over an initial time window, from an aerial vehicle 110, traversing an oscillating flight path, at a first time in Block S120; and updating a first weather forecast for a first forecast window succeeding the initial time window based on the initial set of ambient data in Block S114.

The method S100 also includes, at the remote computer system 150, based on the first weather forecast: predicting a first hazardous-risk zone, proximal the oscillating flight path of the aerial vehicle 110, during the first forecast window in Block S112; defining a first altitude band constraining the oscillating flight path of the aerial vehicle 110 during a first time window succeeding the initial time window in Block S140, the first altitude band defining a first absolute minimum altitude and a first absolute maximum altitude intersecting the first hazardous-risk zone; and defining a first alternative maximum altitude, between the first absolute minimum altitude and the first absolute maximum altitude, proximal a first boundary of the first hazardous-risk zone for the first time window in Block S144. The method S100 further includes, at the remote computer system 150, transmitting the first altitude band and the first alternative maximum altitude to the aerial vehicle 110 in Block S150.

The method S100 also includes, at the aerial vehicle 110: detecting a first hazardous atmospheric condition proximal the aerial vehicle 110 while ascending toward the first alternative maximum altitude during the first time window in Block 178; and, in response to detecting the first hazardous atmospheric condition following ascent of the aerial vehicle 110 above the first alternative maximum altitude, triggering a lifting gas actuator 124 in the aerial vehicle 110 to decrease net buoyancy of the aerial vehicle 110 to transition the aerial vehicle 110 from ascent to descent in Block S158.

### 1.2 Variation: Target Escape Velocity to Navigate Through Hazardous Zone

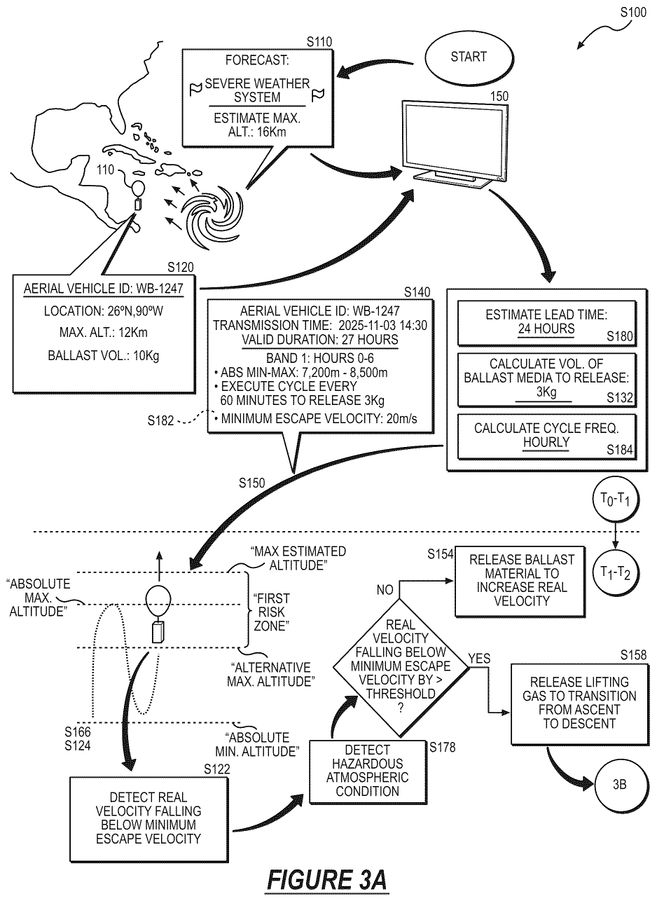

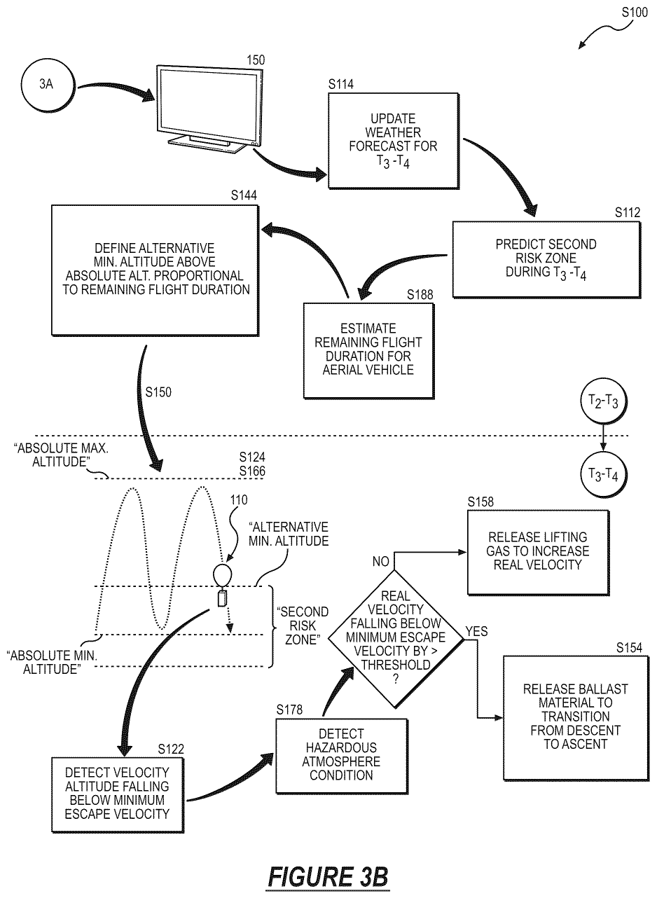

As shown in FIGS. 3A and 3B, one variation of the method S100 includes, at a remote computer system 150: updating a first weather forecast for a first forecast window based on a first set of ambient data, collected by an aerial vehicle 110 traversing an oscillating flight path in Block S114; based on the first weather forecast, predicting a first hazardous-risk zone proximal the oscillating flight path of the aerial vehicle 110 during a first time window and exhibiting an estimated maximum altitude in Block S112; defining a first altitude band constraining the oscillating flight path of the aerial vehicle 110 during the first time window in Block S144, the first altitude band defining a first absolute minimum altitude and a first absolute maximum altitude intersecting the first hazardous-risk zone; estimating a minimum escape velocity for the aerial vehicle 110 to ascend through the first hazardous-risk zone and above the estimated maximum altitude in Block S182; and transmitting the estimated maximum altitude and the minimum escape velocity to the aerial vehicle 110 in Block S150.

The method S100 also includes, at the aerial vehicle 110, while ascending toward the estimated maximum altitude during the first time window: detecting a first hazardous atmospheric condition proximal the aerial vehicle 110 in Block S178; and detecting a first vertical ascent velocity of the aerial vehicle 110 in Block S122. The method S100 also includes, at the aerial vehicle 110, in response to detecting the first hazardous atmospheric condition and in response to the first vertical ascent velocity falling below the minimum escape velocity, triggering a lifting gas actuator 124 (e.g., coupled to the lifting gas valve 122) in the aerial vehicle 110 to decrease net buoyancy of the aerial vehicle 110 to transition the aerial vehicle 110 from ascent to descent in Block S154.

### 1.3 Variation: Weather Forecast+Target Flight Plan

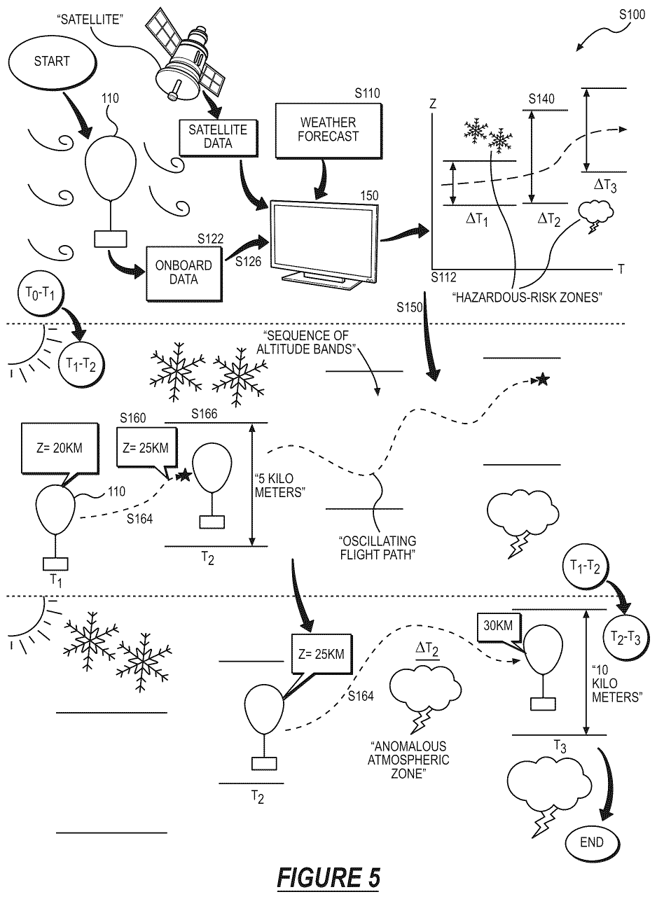

As shown in FIG. 5, one variation of the method S100 includes, at a remote computer system 150 (or “ground station”): accessing a weather forecast for a time window in Block S110; based on the weather forecast, forecasting a constellation of hazardous-risk zones characterized by elevated risk exposure (e.g., damage risk, added weight risk, shortened flight time risk) to an aerial vehicle 110 (e.g., balloon module, sail module) during the time interval in Block S112; accessing a current position (e.g., a three-dimensional geospatial position) of the aerial vehicle 110 in Block S120.

This variation of the method S100 also includes, at the remote computer system 150: defining an oscillating flight path for the aerial vehicle 110, from the current position of the aerial vehicle 110, that avoids the constellation of hazardous-risk zones; defining a sequence of altitude bands predicted to maintain the aerial vehicle 110 proximal the oscillating flight path based on forecast wind velocities represented in the weather forecast during the flight duration time window in Block S140; and transmitting the sequence of altitude bands to the aerial vehicle 110 in Block S150.

### 1.4 Variation: Maintaining Oscillating Flight Path+Macro Controls

This variation of the method S100 further includes, at the aerial vehicle 110: retrieving a target altitude band, from the sequence of altitude bands, assigned to the aerial vehicle 110 at a current time in Block S160; based on a current position of the aerial vehicle 110, calculating a first altitude adjustment (e.g., release of ballast, release of lifting gas, control surface adjustment) predicted to maneuver the aerial vehicle 110 into the target altitude band; and executing the first altitude adjustment to maneuver the aerial vehicle 110 into the target altitude band in Block S164.

### 1.5 Variation: Anomalous Hazardous Atmospheric Zones+Local Controls

This variation of the method S100 also includes, at the aerial vehicle 110: detecting an anomalous hazardous atmospheric zone (e.g., icing potential, precipitation) within the target altitude band occupied (or approached) by the aerial vehicle 110; calculating a second altitude adjustment (e.g., release of ballast, release of lifting gas, control surface adjustment) predicted to deviate the aerial vehicle 110 from the oscillating flight path and avoid the anomalous hazardous atmospheric zone; and executing the second altitude adjustment to avoid the anomalous hazardous atmospheric zone in Block S164.

### 2. Applications

Generally, Blocks of the method S100 can be executed by a remote computer system 150 (or “ground station”) in cooperation with an aerial vehicle 110 (hereinafter “system”): to avoid exposure of an aerial vehicle 110 to known or forecast large (or “macro”) hazardous atmospheric zones (e.g., high wind shear, low temperature, and/or high humidity regions) while deployed in the atmosphere; to maintain or extend a flight duration of the aerial vehicle 110 by avoiding large forecast and locally-detected hazard conditions that may require release of ballast and/or lifting gas to escape, maintain flight controls, or terminate a flight operation (e.g., emergency landing, preserving aerial vehicle hardware); and thus enable the aerial vehicle 110 to capture high volumes of atmospheric weather data per flight.

### 2.1 Oscillating Flight Path+Altitude Bands

More specifically, the remote computer system 150 can: forecast a constellation of hazardous-risk zones, such as based on a weather forecast output from a weather forecast model (e.g., global weather model, regional weather model, storm-scale weather model); define an oscillating flight path from a current position (e.g., geospatial position) of the aerial vehicle 110 that avoids the constellation of hazardous-risk zones during a flight duration time window; define an altitude band (or a sequence of altitude bands) (e.g., five-kilometer altitude bands, ten-kilometer altitude bands) predicted to maintain the aerial vehicle 110 proximal (or “along”) the oscillating flight path; and transmit this altitude band (or sequence of altitude bands) to the aerial vehicle 110.

For example, the aerial vehicle 110 can include: a balloon module configured to generate aerostatic lift for the aerial vehicle 110; and a sail module 140, suspended from the balloon module via a tether, and configured to induce aerodynamic lift for the aerial vehicle 110 to navigate the balloon module and the sail module 140 into different altitude zones exhibiting different relative wind velocities (or “windshear”). In this example, this difference in relative wind velocities (i.e., composite or average windshear between the balloon module and the sail module 140) carries the aerial vehicle 110 in a horizontal plane in the atmosphere.

Thus, the remote computer system 150 can: retrieve a weather forecast; identify (or “forecast”) a constellation of hazardous atmospheric zones in the atmosphere based on this weather forecast; and implement machine learning, deep learning, search algorithms, and/or combinatorial optimization techniques (e.g., decision tree, heuristic search, multi-objective gradient descent) to define an oscillating flight path navigable by the aerial vehicle 110, such as by changing altitude (e.g., releasing lifting gas, releasing ballast, modifying a control surface 142), which positions the aerial vehicle 110 (e.g., the balloon module and the sail module 140) at varying altitudes with different forecast wind velocities that maneuver the aerial vehicle 110 in a horizontal plane.

Additionally, the remote computer system 150 can define an altitude band (or a sequence of altitude bands) that, when occupied by the aerial vehicle 110, are forecast to result in exposure of the aerial vehicle 110 to different wind velocities that will maneuver (or “drag”) the aerial vehicle 110 proximal (or “along”) the oscillating flight path. Furthermore, in addition to defining the oscillating flight path that avoids hazardous atmospheric zones in the atmosphere, the remote computer system 150 can also define an oscillating flight path that intersects target locations of interest for atmospheric weather data capture.

Other variations of the system 100 can include a single instance of a balloon module, a single instance of a sail module 140, any combination of balloon modules and sail modules, and/or any aerial vehicle (e.g., aerostatic aerial vehicle, aerodynamic aerial vehicle).

### 2.2 Flight Controls for Macro and Local Hazard Avoidance

The aerial vehicle 110 can then execute macro closed-loop controls to: maneuver to a new altitude, such as by venting lifting gas, dropping ballast, and/or adjusting a control surface 142, to navigate into a current target altitude band specified in a sequence of altitude bands; both maintain the aerial vehicle 110 along the oscillating flight path and avoid adverse atmospheric conditions during a flight time duration window (e.g., five days); and collect atmospheric weather data along this oscillating flight path.

For example, the aerial vehicle 110 can: retrieve a target altitude band, from the sequence of altitude bands, assigned to the aerial vehicle 110 at a current time; based on a current position of the aerial vehicle 110, calculate a ballast release volume predicted to maneuver the aerial vehicle 110 into the target altitude band; and trigger a ballast module 130 to drop ballast accordingly to maneuver the aerial vehicle 110 into the target altitude band. The aerial vehicle 110 can then repeat this process for each altitude band in the sequence of altitude bands to: maintain the aerial vehicle 110 proximal (e.g., within 0.2 kilometers of) the oscillating flight path; and avoid forecast hazardous atmospheric zones nearby (e.g., within 100 kilometers).

Additionally, the aerial vehicle 110 can locally detect a nearby anomalous hazardous atmospheric zone that was not detected in the weather forecast and/or represented in the constellation of the hazardous atmospheric zones, such as: a local icing risk condition indicated by high local humidity and low local temperatures; or local updrafts indicated by rapid altitude changes. The aerial vehicle 110 can then execute local closed-loop controls to maneuver to a new altitude, such as by venting lifting gas, dropping ballast, and/or adjusting a control surface 142, to avoid the anomalous hazardous atmospheric zone, such as: to move vertically toward a lower-humidity or higher-temperature zone; and/or to move vertically into a different wind shear condition between a balloon and sail of the aerial vehicle 110, thereby moving the aerial vehicle 110 laterally away from local updrafts.

For example, the aerial vehicle 110 can: access a temperature value from a temperature sensor arranged at the aerial vehicle 110 during a flight operation; and, in response to the temperature value falling below a threshold temperature value (e.g., 30 degrees Fahrenheit), detect an icing potential proximal the aerial vehicle 110. Accordingly, the aerial vehicle 110 can then: calculate a lifting gas release volume predicted to result in a reduction in altitude of the aerial vehicle 110 below this icing potential; and trigger the balloon module to release this volume of lifting gas, thereby inducing negative lift of the aerial vehicle 110 enabling the aerial vehicle 110 to fall below this icing potential, and deviating the aerial vehicle 110 from the oscillating flight path.

### 2.3 Flight Path Return

In one application, the aerial vehicle 110 can: maintain the new altitude for a duration of time (or “dwell time period”) to avoid the anomalous hazardous atmospheric zone; following this duration of time, reverse the previous altitude change to return the aerial vehicle 110 to the target altitude band; and, upon returning to the target altitude band, maintain neutral buoyancy to maneuver the aerial vehicle 110 along the oscillating flight path.

In another application, the remote computer system 150 can repeat the steps described above to recalculate a flight path after the aerial vehicle 110 deviates from a current flight path by more than a threshold distance and/or given a new weather forecast generated in light of new onboard weather data from the aerial vehicle 110 and/or other deployed aerial vehicles.

Therefore, rather than executing closed-loop controls to adjust altitude within a single altitude band, the aerial vehicle 110 can: receive a sequence of altitude bands that maintains the aerial vehicle 110 proximal an oscillating flight path that avoids the constellation of hazardous-risk zones; and execute macro and local closed-loop controls to adjust an altitude of the aerial vehicle 110 within the sequence of altitude bands and to maintain the aerial vehicle 110 proximal an oscillating flight path.

### 2.4 Adaptive Hazard Response and Resource-Aware Flight Control

In one application, the aerial vehicle 110 can selectively execute altitude maneuvers during navigation of an altitude band, such as to maintain hazard awareness while conserving finite onboard resources (e.g., ballast material, lifting gas) during a flight operation. In particular, the remote computer system 150 can delegate hazard-response maneuvers to the aerial vehicle 110 based on forecast reliability, predicted connectivity loss, or atmospheric uncertainty represented in the weather forecast. More specifically, the remote computer system 150 can encode explicit hazard-response instructions (e.g., hazardous atmospheric conditions and alternative minimum (or maximum) altitudes) into altitude bands, such as when forecast conditions exhibit relatively high reliability. Alternatively, in one variation, the remote computer system 150 can transmit generic altitude-band specifications (e.g., minimum and maximum altitudes of the altitude band) that omit hazard-response instructions, such as when forecast conditions exhibit greater uncertainty or predicted connectivity loss.

In this variation, the aerial vehicle 110 can define threshold ranges for detecting hazardous atmospheric conditions, such as by interpreting bandwidth as implicitly encoding forecast confidence or atmospheric risk level. For example, a narrow bandwidth can indicate a relatively high atmospheric risk, such that the aerial vehicle 110 derives relatively smaller trigger thresholds (e.g., a minimum temperature of 0° C., a maximum humidity of 90%) to detect hazardous atmospheric conditions. Conversely, a wider bandwidth can indicate a relatively low atmospheric risk, such that the aerial vehicle 110 derives relatively larger trigger thresholds to navigate the altitude band with conservative hazard-response sensitivity.

Additionally, the remote computer system 150 can define oscillating flight paths for the aerial vehicle 110 that conserve limited onboard resources while maintaining hazard response. For example, the remote computer system 150 can command the aerial vehicle 110 to: implement a sail module 140 configured to generate aerodynamic lift (e.g., rather than releasing ballast material) when the altitude band exhibits wind shear within a target range; postpone venting of lifting gas when the aerial vehicle 110 encounters atmospheric conditions (e.g., icing conditions) predicted to induce mass accumulation on and passive descent of the aerial vehicle 110; execute altitude-cycling maneuvers prior to intersection with a tall severe weather system to increase maximum attainable altitude of the aerial vehicle 110; and/or or classify a near-end-of-life aerial vehicle and command intentional penetration of a severe weather system to collect high-value atmospheric data during a terminal flight window. Therefore, the aerial vehicle 110 can dynamically execute resource-aware maneuvers to conserve finite onboard resources at the aerial vehicle 110 while maximizing data capture within the atmosphere.

### 3. System

Generally, as shown in FIG. 1A, the system 100 includes: an aerial vehicle 110 (or fleet of aerial vehicles) configured to deploy across locations and altitudes in the atmosphere to record atmospheric data; and a remote computer system 150 in communication with the aerial vehicle 110. The remote computer system 150 is configured to: receive data packages (e.g., an atmospheric data package) from the aerial vehicle 110; and, based on this data package, generate a flight path (e.g., a set of time-bounded altitude bands) for the aerial vehicle 110 that avoids predicted adverse weather conditions (e.g., rain, humidity, icing) in the atmosphere.

### 3.1 Remote Computer System

In one implementation, the remote computer system 150 includes: a communication module (e.g., an antenna, a receiver); and a controller (e.g., computer, server) configured to receive (e.g., via the communication module) data packages from the aerial vehicle 110 (e.g., a balloon module, a sail module 140) and transmit (e.g., via the communication module) a sequence of altitude bands to the aerial vehicle 110 that avoids adverse weather conditions (e.g., turbulence, icing, precipitation intensity, severe weather) in the atmosphere. More specifically, the remote computer system 150 is configured to: process incoming data packages (e.g., atmospheric data packages) across a fleet of aerial vehicles, such as by ingesting these incoming data packages into a weather forecast model; define an oscillating flight path for the aerial vehicle 110 that avoids adverse weather conditions based on weather-related risk levels represented in a weather forecast output by the weather forecast model; define a sequence of altitude bands (e.g., between five kilometers and ten kilometers) that maintains the aerial vehicle 110 along this oscillating flight path; and transmit this sequence of altitude bands to the aerial vehicle 110.

### 3.2 Aerial Vehicle: Balloon Module

In one implementation, the aerial vehicle 110 includes a set of components similar to those described in U.S. Non-Provisional application Ser. No. 18/780,159, which is hereby incorporated in its entirety by this reference. In particular, the aerial vehicle 110 can include a balloon module (e.g., zero pressure balloon, super pressure balloon) including: an inflatable element 120 (e.g., a balloon) formed of a polymer material (e.g., rubber, latex, silicone, chloroprene, mylar, linear low-density polyethylene, polyethylene terephthalate); and a set of payload instruments (e.g., radiosonde, weathering instrument) coupled to the inflatable element 120, such as via a tether (e.g., paracord, fishing line).

In particular, the inflatable element 120: is configured to contain a lifting gas (e.g., helium) arranged within an interior of the inflatable element 120 to induce aerostatic lift of the balloon module (e.g., zero pressure balloon, super pressure balloon); and includes a lifting gas valve 122 (e.g., wireless valve) configured to release the lifting gas (e.g., helium) stored within the inflatable element 120 during flight of the inflatable element 120 in the atmosphere. Additionally, the set of payload instruments (e.g., radiosonde) can include: a suite of sensors 160 (e.g., temperature sensor, humidity sensor, global positioning unit, pressure sensor, gas sensor, gyroscope, accelerometer, wing speed and direction sensor, load cell, inertial measurement unit); and a local controller 170 configured to read a set of values (e.g., temperature values, position values) from the suite of sensors 160 and transmit the set of values, such as to a remote computer system 150 associated with a remote operator. In one example, the inflatable element 120 defines an elongated tubular structure exhibiting a length ten times greater than a diameter of a circular cross-section of the elongated tubular structure. The balloon module can further include a set of solar panels and/or a battery configured to supply power to the set of payload instruments.

In one implementation, the balloon module functions as a hybrid system that is operable: in a first configuration (e.g., zero pressure configuration) in which the inflatable element 120 is partially inflated with the lifting gas and/or is open at a bottom end; and a second configuration (e.g., super pressure configuration) in which the inflatable element 120 is fully inflated within the lifting gas. For example, during a flight operation the aerial vehicle 110 can: detect a current altitude of the aerial vehicle 110 exceeding a target altitude; trigger a vent at the inflatable element 120 to release the lifting gas contained within the inflatable element 120; and induce descent of the aerial vehicle 110 toward the target altitude.

### 3.3 Aerial Vehicle: Sail Module

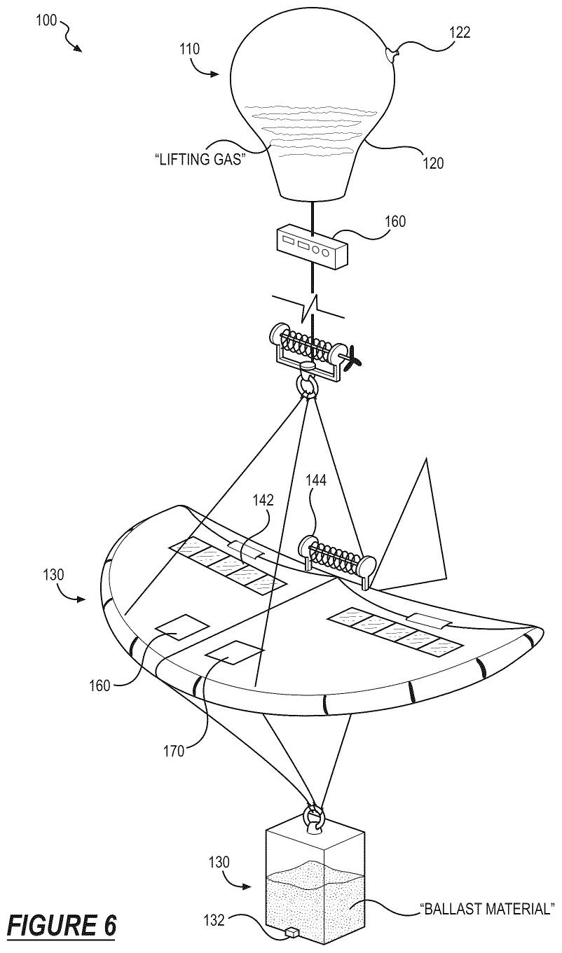

In one variation, as shown in FIG. 6, the aerial vehicle 110 includes a set of components similar to those described in U.S. Non-Provisional application Ser. No. 18/780,159, which is hereby incorporated in its entirety by this reference. In particular, the aerial vehicle 110 can include a sail module 140: coupled to the inflatable element 120 (e.g., via a tether, paracord); defining a substantially horizontal plane (e.g., X, Y plane) arranged below the inflatable element 120 during flight of the aerial vehicle 110 in the atmosphere; and configured to pitch (i.e., tilt forward or backward) along a pitch axis to modify (e.g., increase, decrease) aerodynamic lift applied to the aerial vehicle 110. In particular, the sail module 140 includes a control surface 142 defining: a leading edge configured to distribute wind speed across surfaces (e.g., top surface, bottom surface) of the control surface 142; a trailing edge arranged opposite the leading edge; and a chord line extending from the leading edge toward the trailing edge of the control surface 142 and cooperating with the leading edge and the trailing edge to distribute pressure (i.e., resulting from air flow_across the top surface and bottom surface of the control surface 142 to induce a lifting force on the control surface 142 and therefore the overall (i.e., the balloon module and sail module) system.

Additionally, the aerial vehicle 110 can include: a power source, such as a battery and/or an array of solar panels arranged across the top surface of the control surface 142; a motorized spool 144 coupled to the trailing edge of the control surface 142 and the power source and configured to modify (e.g., increase, decrease) a pitch angle of the control surface 142 relative to wind velocity; and a local controller 170 (e.g., a local computer system coupled to the sail module 140 120) coupled to the motorized spool 144 and configured to trigger the motorized spool 144 according to an altitude control prompt, such as from the remote computer system 150, stored in local memory of the local controller 170, and/or calculated from onboard data. Accordingly, during a flight operation, the local controller 170 can trigger the motorized spool 144 to: increase a pitch angle of the control surface 142 relative an angle of attack for a current wind velocity to induce aerodynamic lift across the control surface 142, thereby applying a lifting force to the aerial vehicle 110; and/or decrease a pitch angle of the control surface 142 relative the angle of attack for the current wind velocity to attenuate (or “decrease”) aerodynamic lift induced across the sail module 140 and therefore the aerial vehicle 110.

### 3.4 Fleet of Aerial Vehicles

In one variation, the system 100 includes a fleet of aerial vehicles (e.g., containing balloon modules and/or sail modules) that are configured to deploy across various locations and altitudes in the atmosphere. Each instance of an aerial vehicle 110 can then: record high-resolution localized atmospheric data, such as from a local suite of sensors 160; and transmit this localized atmospheric data to a remote computer system 150 (or multiple remote computer systems) during a flight operation.

Although the aforementioned implementation describes a fleet of aerial vehicles containing balloon modules and/or sail modules, other variations of the system 100 can include the fleet of aerial vehicles containing drones, gliders, dropsondes, etc.

### 4. Weather Forecast

Block S110 of the method S100 recites accessing a weather forecast for a time window. Generally, in Block S110, the remote computer system 150 can access a weather forecast for an atmospheric region proximal an aerial vehicle 110 (e.g., a balloon module, a sail module 140) deployed in the atmosphere. For example, the remote computer system 150 can: generate a prompt requesting predicted atmospheric data over a target time window (e.g., five days) for an atmospheric encompassing an aerial vehicle 110 (or multiple aerial vehicles); transmit the prompt to a previously-generated weather prediction model (e.g., global weather model, regional weather model, storm-scale weather model); and receive, from this previously-generated weather prediction model, predicted atmospheric data during the target time window for this atmospheric region.

### 4.1 Data Aggregation+Hazardous-risk Zone Prediction

Blocks of the method S100 recite, at the remote computer system 150: receiving an initial geospatial location of an aerial vehicle 110, traversing an oscillating flight path, at an initial time and an initial set of ambient data, recorded over an initial time window, from the aerial vehicle 110 in Block S120; updating a future weather forecast for a future forecast window based on the initial set of ambient data in Block S114; and, based on the weather forecast, predicting a hazardous-risk zone, proximal the oscillating flight path of the aerial vehicle 110, during the future forecast window in Block S112.

Generally, the remote computer system 150 can: define a region in real space (e.g., three-dimensional boundary box) encompassing a fleet of aerial vehicles currently deployed in the atmosphere; and aggregate known and/or predicted (or “forecasted”) atmospheric data (e.g., air pressure, humidity, temperature, wind speed) specified for the selected region in real space. More specifically, in Block S120, the remote computer system 150 can access: real-time high-resolution onboard atmospheric data (or “atmospheric data”) from an aerial vehicle 110 (e.g., in a fleet of aerial vehicles) occupying the region; and/or real-time high-resolution satellite atmospheric data, such as from a satellite network, specified for the selected region.

In one implementation, the remote computer system 150 can: access an initial weather forecast, constructed based on a population of ambient data collected by a population of aerial vehicles, for an initial time window; project a set of ambient data, collected by the aerial vehicle 110, into the initial weather forecast; and extrapolate a future weather forecast from the initial weather forecast based on the initial set of ambient data.

In one implementation, the remote computer system 150 can forecast or predict a constellation of hazardous-risk zones characterized by elevated risk exposure (e.g., damage risk, added weight risk, shortened flight time risk) to the aerial vehicle 110. In particular, based on the weather forecast, the remote computer system 150 can predict a hazardous-risk zone, within an atmospheric region, such as an atmospheric region intersecting a severe weather system (e.g., tropical storms), and an icing-risk zone, a turbulence-risk zones, or a high-precipitation zone.

In one example, the remote computer system 150 can implement interpolation techniques to generate a spatial representation (e.g., n-dimensional space) occupying the aerial vehicle 110 for the constellation of hazardous-risk zones as a function of position (e.g., horizontal position, altitude) and a flight duration time window. Therefore, the remote computer system 150 can implement a previously-generated weather forecast model to forecast hazardous atmospheric zones predicted to intersect a trajectory of a particular aerial vehicle.

In one example, the remote computer system 150 can then feed this high-resolution atmospheric data into the previously-generated weather prediction model to receive predicted atmospheric data (e.g., high-resolution, low-resolution data), specified for the selected region, over a target time window (e.g., five days). In another example, the remote computer system 150 can implement interpolation techniques, as described above, to calibrate and cross-validate the predicted atmospheric data output from the weather forecast model with this high-resolution atmospheric data. In another example, the remote computer system 150 can update the weather forecast model for future forecast predictions based on the high-resolution atmospheric data. In another example, the remote computer system 150 can: retrieve onboard atmospheric data from all currently-deployed aerial vehicles in the atmosphere; and implement these high-resolution atmospheric datasets to validate and/or calibrate predicted atmospheric datasets from the weather forecast. Therefore, the remote computer system 150 can implement high-resolution localized atmospheric data to: generate and/or calibrate predicted atmospheric data over a target time window (e.g., five days); and represent the high-resolution atmospheric data and the predicted atmospheric data as a constellation of hazardous-risk zones within the region characterized by elevated risk exposure (e.g., damage risk from excess temperatures, added weight risk, shortened flight time risk) to the aerial vehicle 110.

### 4.1.1 Satellite Atmospheric Data

In one variation, the remote computer system 150 can receive real-time high-resolution satellite atmospheric data, such as from a satellite network, specified for a region in real space, occupying an aerial vehicle 110 (or multiple aerial vehicles). For example, the remote computer system 150 can retrieve cloud cover specifications, precipitation estimates, and atmospheric conditions specified for a selected region in real space in the atmosphere. Accordingly, the remote computer system 150 can implement interpolation techniques, as described above, to validate and/or calibrate predicted atmospheric data from the weather forecast.

### 5. Altitude-Band Definition+Macro Controls

Blocks of the method S100 recite, at the remote computer system 150: defining an altitude band constraining the oscillating flight path of the aerial vehicle 110 during a time window in Block S140; and defining an alternative minimum (or maximum) altitude, within the altitude band, proximal a boundary of a hazardous-risk zone intersecting the altitude band in Block S144. Generally, as shown in FIG. 5, the remote computer system 150 can implement the weather forecast to: define an oscillating flight path for the aerial vehicle 110 that avoids hazardous atmospheric zones; define a sequence of time-bounded altitude bands (or “sequence of altitude bands”) predicted to maintain the aerial vehicle 110 along this oscillating flight path in Block S140; define an alternative minimum (or maximum) altitude defining a target altitude for the aerial vehicle 110 to approach to collect ambient data from the hazardous-risk zone in Block S144; and transmit this altitude band and alternative minimum (or maximum) altitude to the aerial vehicle 110 in Block S150.

In one implementation, the remote computer system 150 can define an altitude band (or a sequence of altitude bands) for navigation by the aerial vehicle 110 that is predicted to extend flight duration toward a maximum remaining flight duration of the aerial vehicle 110 while maximizing atmospheric data collection and avoiding hazardous atmospheric zones. In particular, the remote computer system 150 can implement the weather forecast and a set of resource constraints—such as a remaining ballast volume and a remaining lifting gas volume—to define altitude bands that: minimize unnecessary altitude transitions; maintain the aerial vehicle 110 within atmospheric regions predicted to yield high-value atmospheric data; reduce exposure to icing-risk, turbulence-risk, or high-precipitation zones; and extend flight duration by minimizing unnecessary altitude changes.

In one implementation, the remote computer system 150 can: access a current position (e.g., horizontal position, altitude) of an aerial vehicle 110 currently deployed in the atmosphere; and access or estimate a maximum remaining flight duration (e.g., five days) of the aerial vehicle 110. The remote computer system 150 can then implement search algorithms and/or combinatorial optimization techniques (e.g., decision tree, constraint satisfaction, heuristic search) to define an oscillating flight path that avoids hazardous atmospheric zones (e.g., turbulence, icing, precipitation intensity, severe weather) indicated in the weather forecast. Additionally or alternatively, the remote computer system 150 can define an oscillating flight path that aligns with a target scope of data collection, such as to record atmospheric data at target atmospheric regions.

In one implementation, the remote computer system 150 can define an altitude band (or a sequence of altitude bands) that maintains the aerial vehicle 110 along a particular oscillating flight path based on forecast wind velocities represented in the weather forecast during the time window. In particular, the remote computer system 150 can define an altitude band: constraining the oscillating flight path of the aerial vehicle 110 during a particular time window; and defining an absolute minimum altitude and an absolute maximum altitude.

For example, the remote computer system 150 can define a sequence of altitude bands, wherein each altitude band spans a relatively wide altitude range (or “bandwidth”), such as between 5,000 and 35,000 feet. In one example, the remote computer system 150 can: define a sequence of altitude bands including a first altitude band between 10,000 feet and 25,000 feet for navigation by the aerial vehicle 110 during a first time window, and a second altitude band between 18,000 feet and 35,000 feet for navigation by the aerial vehicle 110 during a second time window succeeding the first time window; and transmit this sequence of altitude bands to the aerial vehicle 110 for the aerial vehicle 110 to execute in sequence. The aerial vehicle 110 can then: receive the first and second altitude bands from the remote computer system 150; navigate the first altitude band during the first time window; and navigate the second altitude band during the second time window. More specifically, in response to absence of a new altitude band specified by the remote computer system 150 for the second time window, the aerial vehicle 110 can: retrieve the second altitude band from the sequence of altitude bands; and navigate the second altitude band during the second time window.

Alternatively, the remote computer system 150 can: define an oscillating flight path including a sequence of waypoints; and define a sequence of altitude bands wherein each altitude band spans a relatively narrow altitude range (or “bandwidth”), such as between 1,000 and 2,000 feet. In one example, the remote computer system 150 can define a sequence of altitude bands including: a first altitude band between 1,000 feet and 2,500 feet for navigation by the aerial vehicle 110 during a first time window, the first altitude band intersecting a first waypoint, in a sequence of waypoints, during the first time window; and a second altitude band between 2,000 feet and 3,00 feet for navigation by the aerial vehicle 110 during a second time window succeeding the first time window, the second altitude band intersecting a second waypoint, in a sequence of waypoints, during the first time window. The remote computer system 150 can then transmit this sequence of altitude bands to the aerial vehicle 110 for the aerial vehicle 110 to execute in sequence. The aerial vehicle 110 can then implement methods and techniques described above to navigate the sequence of altitude bands.

In one implementation, the remote computer system 150 can: based on presence of a hazardous-risk zone within an altitude band, define an alternative minimum (or maximum) altitude, between the absolute minimum altitude and the absolute maximum altitude of the altitude band, proximal a boundary of the hazardous-risk zone; and transmit this altitude band and alternative minimum (or maximum) altitude to the aerial vehicle 110. In particular, for a particular altitude band, the remote computer system 150 can define an absolute minimum (or maximum) altitude of the altitude band that: defines a target altitude for the aerial vehicle 110 to approach to collect ambient data from a hazardous-risk zone; and constrains the oscillating flight path of the aerial vehicle 110 above (or below) a region of the hazardous-risk zone predicted to terminate operation of the aerial vehicle 110. Furthermore, for the particular altitude band, the remote computer system 150 can define an alternative minimum (or maximum) altitude: located above (or below) the hazardous-risk zone; and defining an alternative altitude for the aerial vehicle 110 to descend below (or ascend above) prior to transitioning from descent to ascent (or ascent to descent) to avoid hazardous atmospheric conditions within the hazardous-risk zone.

In one example, the remote computer system 150 can: access or estimate a maximum remaining flight duration (e.g., five days) of the aerial vehicle 110; and define the alternative minimum (or maximum) altitude above (or below) the absolute minimum (or maximum) altitude by an offset distance proportional to the remaining flight duration. The aerial vehicle 110 can then execute closed-loop controls to maneuver within the altitude band to avoid forecasted hazardous atmospheric zones during this flight operation, as described below.

### 5.1 Encoded Altitude-Band Instructions for Hazard Response

In one variation, Block S142 of the method S100 recites, at the remote computer system 150, defining the hazardous atmospheric condition. Generally, the remote computer system 150 can implement methods and techniques described above to define an altitude band (or a sequence of altitude bands) and, for a particular altitude band, encode explicit, band-specific instructions that specify: a time window for navigation and a hazardous atmospheric condition corresponding to the altitude band. In particular, the remote computer system 150 can encode these instructions into a command for receipt and execution by the aerial vehicle 110, thereby minimizing onboard computational load at the aerial vehicle 110 by providing pre-defined instructions for navigation and hazard response.

In one implementation, the remote computer system 150 can implement methods and techniques described above to: specify a particular time window for the aerial vehicle 110 to navigate an altitude band; define an absolute minimum altitude (e.g., 10,200 meters) and an absolute maximum altitude (e.g., 10,900 meters) of the altitude band; and, based on a weather forecast for the time window, define a hazardous-risk zone, within the altitude band, predicted to impose elevated flight-performance risks, increased ballast consumption, and/or increased structural loading on the aerial vehicle 110.

The remote computer system 150 can then define a set of (i.e., one or more) hazardous atmospheric condition(s) for the altitude band that indicate hazardous local atmospheric conditions within the altitude band (or the hazardous-risk zone). For example, the remote computer system 150 can define: a temperature-based condition specifying detection of a temperature value below a minimum temperature within an icing-risk zone; a humidity-based condition specifying detection of a humidity value exceeding a maximum humidity within a precipitation-intensity zone; a pressure-differential condition specifying detection of a pressure drop exceeding a threshold pressure gradient; or a vertical-velocity condition specifying detection of a vertical-speed anomaly indicative of local updrafts within a turbulence-risk zone.

Accordingly, to reduce onboard computational load at the aerial vehicle 110, the remote computer system 150 can: encode hazardous atmospheric condition(s) within altitude bands; encode alternative minimum (or maximum) altitudes for the aerial vehicle 110 to implement responsive to detection of hazardous atmospheric condition(s); and encode hazardous atmospheric condition(s) that represent which atmospheric-sensor readings are relevant within each altitude band. Therefore, the remote computer system 150 can communicate a comprehensive set of hazard-response instructions to the aerial vehicle 110 to conserve onboard power and compute resources at the aerial vehicle 110.

### 5.2 Altitude-Band Definition Without Encoded Instructions

In one variation, rather than transmitting explicit hazardous atmospheric conditions and alternative minimum (or maximum) altitudes for each altitude band, the remote computer system 150 can transmit an altitude band (or a sequence of altitude bands) without embedding hazard-specific instructions, such as to delegate hazard-interpretation logic to the aerial vehicle 110 to reduce data-transmission volume from the remote computer system 150. For example, for each altitude band, the remote computer system 150 can: define a bandwidth (e.g., 120 meters) for the altitude band; and transmit this altitude band (and bandwidth) to the aerial vehicle 110.

In one example, the remote computer system 150 can define a relatively wide bandwidth for an altitude band, such that the aerial vehicle 110 can traverse a larger vertical extent while navigating the altitude band and record a greater volume of atmospheric data (e.g., vertical humidity profiles, pressure gradients, turbulence layers) during the time window. Thus, the aerial vehicle 110 can adjust vertical-sampling depth based on bandwidth while collecting atmospheric data.

### 5.2.1 Connectivity-Risk Regions

In one variation, Blocks of the method S100 recite: accessing a current location of the aerial vehicle 110 in Block S120; calculating a risk score for loss of connectivity with the aerial vehicle 110 based on the current location of the aerial vehicle 110 in Block S172; and defining an altitude band, specifying a time window proportional to the risk score in Block S140. In particular, the remote computer system 150 can define connectivity-risk regions—such as regions of limited satellite visibility, ground-station occlusion, or predicted radio-frequency attenuation—and assign longer time windows to connectivity-risk regions exhibiting higher predicted probability of connectivity loss (e.g., a risk score exceeding 0.85) and shorter time windows to connectivity-risk regions exhibiting lower predicted probability of connectivity loss (e.g., a risk score less than 0.40).

6. In this variation, the remote computer system 150 can: access a current location of the aerial vehicle 110 at a first time; calculate a risk score for loss of connectivity with the aerial vehicle 110 during a future time window based on the current location of the aerial vehicle 110; and specify a time window for the altitude band proportional to the risk score, for navigation by the aerial vehicle 110 during the future time window. More specifically, a high connectivity-loss risk score can indicate a relatively high probability that the aerial vehicle 110 may lose uplink connectivity during the future time window. Accordingly, the remote computer system 150 can define a longer time window for this altitude band, such as to enable the aerial vehicle 110 to execute autonomous navigation through the connectivity-risk region without requiring updated flight plans from the remote computer system. Conversely, a low connectivity-loss risk score can indicate a low probability of connectivity loss, permitting more frequent flight plan updates by the aerial vehicle 110. Therefore, the remote computer system 150 can ensure operational continuity during communication outages, decrease satellite-uplink requirements, and increase robustness of flight-plan delivery, such as during degraded connectivity conditions. Altitude Band Navigation+Data Collection

Blocks of the method S100 recite, at the aerial vehicle 110: accessing an altitude band for the aerial vehicle 110 to navigate in Block S160; navigating the altitude band during a time window specified for the altitude band in Block S166; executing an altitude adjustment to maneuver the aerial vehicle 110 along the oscillating flight path in Block S164; recording a set of ambient data, representing local atmospheric conditions proximal the aerial vehicle 110, while navigating the altitude band during the time window in Block S124; and transmitting the set of ambient data to the remote computer system 150 in Block S126. Generally, the aerial vehicle 110 can: access or receive an altitude band (or a sequence of altitude bands) defined by the remote computer system 150 in Block S160; autonomously navigate within the atmosphere according to the altitude band (or the sequence of altitude bands) in Block S166; and autonomously execute altitude maneuvers to maintain the oscillating flight path in Block S164.

In one variation, Blocks of the method S100 recite, at the aerial vehicle 110: calculating a volume of lifting gas to release from an inflatable element 120 of the aerial vehicle 110 to decrease altitude of the aerial vehicle 110 in Block S134; and actuating a lifting gas valve 122, coupled to the inflatable element 120, to release the volume of lifting gas from the inflatable element 120 in Block S158. In particular, in this variation, the aerial vehicle 110 can trigger the lifting gas valve 122 to vent a lifting gas to decrease altitude of the aerial vehicle 110 (e.g., below an icing atmospheric condition).

In another variation, Blocks of the method S100 recite, at the aerial vehicle 110: calculating a volume of ballast material to release from a ballast module 130, arranged in the aerial vehicle 110, to increase altitude of the aerial vehicle 110 in Block S132; and actuating a ballast valve 132, coupled to the ballast module 130, to release the volume of ballast material from the ballast module 130 in Block S154. In particular, in this variation, the aerial vehicle 110 can trigger the ballast module 130 to drop ballast media to increase altitude of the aerial vehicle 110 (e.g., above a precipitation atmospheric condition).

In one implementation, during a flight operation, the aerial vehicle 110: can record onboard atmospheric data (e.g., e.g., air pressure, humidity, temperature, wind speed) from the suite of sensors 160 arranged on the aerial vehicle 110; and iteratively (e.g., every ten minutes, hourly) transmit this onboard atmospheric data to the remote computer system 150 and/or multiple computer systems proximal the aerial vehicle 110, such as in response to conclusion of a particular time window specified for an altitude band. In particular, the aerial vehicle 110 can: access a set of signals output by the suite of sensors 160 arranged on the aerial vehicle 110 during a time window; extract a set of ambient data, representing local atmospheric conditions proximal the aerial vehicle 110, from the set of signals; and transmit the set of ambient data to the remote computer system 150. The remote computer system 150 can then access or receive the ambient data from the aerial vehicle 110, such as to define new altitude bands for the aerial vehicle 110 and/or update a weather forecast for a future time window.

### 7. Hazardous Condition Detection+Local Controls

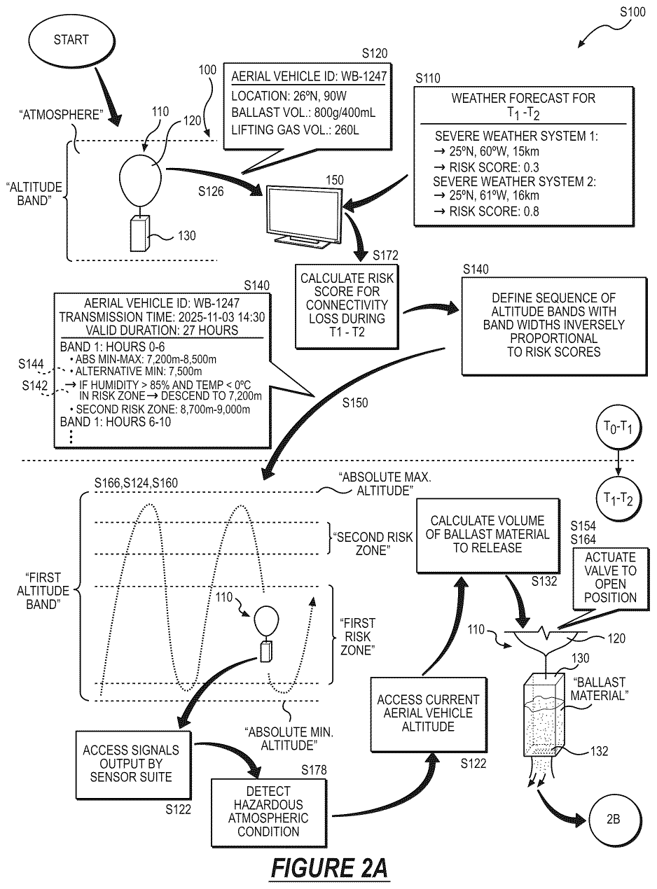

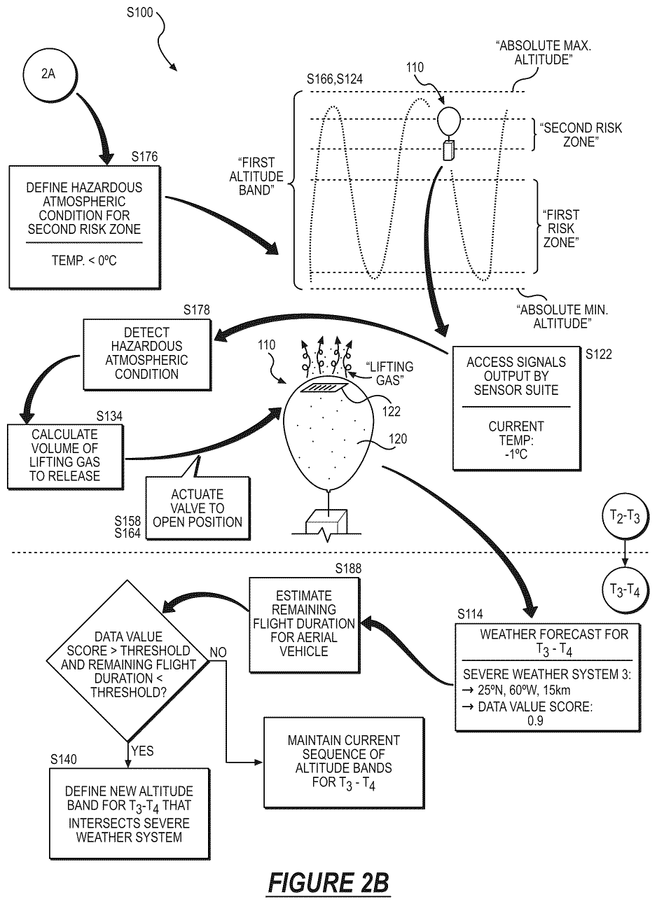

Blocks of the method S100 recite, at the aerial vehicle 110: navigating an altitude band during a time window specified for the altitude band in Block S166; accessing a set of signals output by a suite of sensors 160 arranged on the aerial vehicle 110 while navigating the altitude band in Block S122; based on the set of signals, detecting a hazardous atmospheric condition proximal the aerial vehicle 110 in Block S178; and, in response to detecting the hazardous atmospheric condition, triggering a ballast actuator 134 (e.g., coupled to the ballast valve 132) in the aerial vehicle 110 to increase net buoyancy of the aerial vehicle 110 to transition the aerial vehicle 110 from descent to ascent in Block S154. Generally, as shown in FIGS. 1A, 1B, 2A, and 2B, while navigating a particular altitude band, the aerial vehicle 110 can: access onboard atmospheric data from the suite of sensors 160 arranged on the aerial vehicle 110 in Block S122; and detect a hazardous atmospheric condition based on these data in Block S178. Additionally, in Block S154, in response to detecting the hazardous atmospheric condition, the aerial vehicle 110 can then execute closed-loop controls to maneuver (e.g., adjust altitude) to avoid the hazardous atmospheric condition.

In one example, the remote computer system 150 can predict: a first hazardous-risk zone, proximal the oscillating flight path of the aerial vehicle 110 during a first time window, exhibiting atmospheric turbulence or rapid wind shear; and a second hazardous-risk zone, proximal the oscillating flight path of the aerial vehicle 110 during a second time window, exhibiting temperatures predicted to yield ice accumulation on the aerial vehicle 110. Then, while navigating within the first hazardous-risk zone, the aerial vehicle 110 can: detect the first hazardous atmospheric condition based on a first signal output by an inertial sensor (e.g., an accelerometer) and representing rapid vertical acceleration or descent rate exceeding a threshold rate; and trigger the ballast valve 132, coupled to a ballast module 130 arranged in the aerial vehicle 110, to release ballast material, contained in the ballast module 130 to increase net buoyance of the aerial vehicle 110 and transition the aerial vehicle 110 from descent to ascent.

Additionally, while navigating within the second hazardous-risk zone, the aerial vehicle 110 can detect the second hazardous atmospheric condition in response to detecting a real deceleration of the aerial vehicle 110 (e.g., via an inertial sensor) falling below an expected deceleration of the aerial vehicle 110 during the second time window; and trigger a lifting gas valve 122, coupled to an inflatable element 120 of the aerial vehicle 110, to release lifting gas, contained in the inflatable element 120 to decrease net buoyancy of the aerial vehicle 110 and transition the aerial vehicle 110 from ascent to descent.

Therefore, the aerial vehicle 110 can: maintain contextual awareness of local hazardous atmospheric conditions during a flight operation; and execute closed-loop controls to maneuver the aerial vehicle 110, such as by dropping ballast and/or venting gas, to avoid this local hazardous atmospheric condition.

### 7.1 Local Controls: Encoded Flight-control Instructions

In one implementation, the remote computer system 150 can encode instructions for hazard response within altitude bands and transmit these instructions to the aerial vehicle 110 for execution during a particular time window. In particular, the remote computer system 150 can define an altitude band for navigation by the aerial vehicle 110 during the time window, define a hazardous atmospheric condition indicating hazardous local atmospheric conditions within a hazardous-risk zone in the altitude band, and define an alternative minimum (or maximum) altitude for implementation by the aerial vehicle 110 responsive to detection of the hazardous atmospheric condition. The aerial vehicle 110 can then: access a set of signals output by the suite of sensors 160 (e.g., temperature, humidity, pressure, and vertical-velocity sensors) while navigating the hazardous-risk zone during the time window; detect the hazardous atmospheric condition based on the set of signals; and, in response to detecting the hazardous atmospheric condition, execute the alternative minimum (or maximum) altitude.

In one example, in which the aerial vehicle 110 includes an inflatable element 120 containing lifting gas and a ballast module 130 containing ballast material, the aerial vehicle 110 can execute gas-venting or ballast-release maneuvers to adjust altitude within the altitude band. In particular, the aerial vehicle 110 can access an alternative maximum altitude below the hazardous-risk zone. The aerial vehicle 110 can then, in response to detecting the hazardous atmospheric condition: calculate a volume of lifting gas to release from the inflatable element 120, the volume of lifting gas predicted to decrease altitude from a current altitude (e.g., 17,400 meters) to below a risk-zone maximum altitude (e.g., 17,200 meters); and actuate a lifting gas valve 122 coupled to the inflatable element 120 to vent the volume of lifting gas from the inflatable element 120.

Alternatively, the aerial vehicle 110 can access an alternative minimum altitude above the hazardous-risk zone. The aerial vehicle 110 can then, in response to detecting the hazardous atmospheric condition: access a current altitude of the aerial vehicle 110; calculate a volume of ballast material (e.g., 95 grams) to release from the ballast module 130 to increase altitude from the current altitude to above the hazardous-risk zone; and actuate a ballast valve 132 coupled to the ballast module 130 to release the calculated volume of ballast material from the ballast module 130.

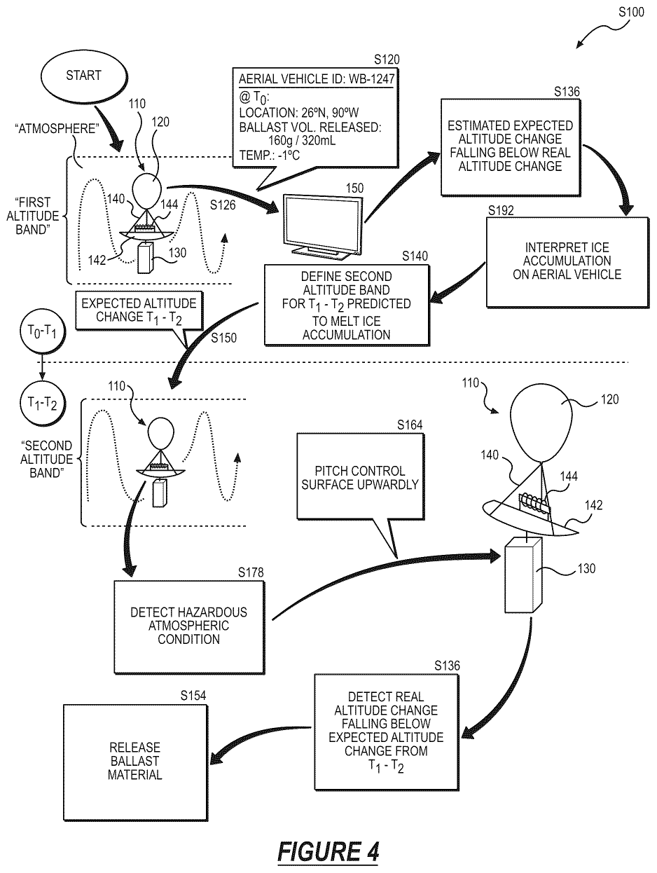

In another example, in which the aerial vehicle 110 includes a sail module 140 suspended below the inflatable element 120, the aerial vehicle 110 can execute aerodynamic-control maneuvers similar to those described in U.S. application Ser. No. 18/780,159 to adjust altitude within the altitude band, as shown in FIG. 4. In particular, the aerial vehicle 110 can access an alternative maximum altitude below the hazardous-risk zone. The aerial vehicle 110 can then, in response to detecting the hazardous atmospheric condition, downwardly actuate a control surface 142, arranged on the sail module 140, to generate negative aerodynamic lift across the control surface 142, such as to decrease altitude without venting lifting gas or releasing ballast material.

Alternatively, the aerial vehicle 110 can access an alternative minimum altitude above the hazardous-risk zone. The aerial vehicle 110 can then, in response to detecting the hazardous atmospheric condition: actuate the control surface 142 of the sail module 140 to upwardly pitch the control surface 142; generate positive aerodynamic lift across the control surface 142; and increase altitude of the aerial vehicle 110 without releasing ballast material.

Additionally, in this example, the aerial vehicle 110 can: access a current altitude (or deceleration) of the aerial vehicle 110 at a particular time while the aerial vehicle 110 navigates toward an alternative maximum altitude via the sail module 140 (e.g., while the control surface 142 is pitched upwardly); and estimate an expected altitude (or an expected deceleration) for the aerial vehicle 110 at the particular time. The aerial vehicle 110 can then, in response to the current altitude (or deceleration) of the aerial vehicle 110 falling below the expected altitude (or expected deceleration): calculate a volume of ballast material to release from the ballast module 130 to increase altitude (or decrease deceleration) of the aerial vehicle 110 from the current altitude to above the hazardous-risk zone; and actuate the ballast valve 132, coupled to the ballast module 130, to release ballast material from the ballast module 130.

Therefore, the aerial vehicle 110 can: reduce consumption of lifting gas and ballast material by delegating altitude-maintenance maneuvers to aerodynamic lift generated by the sail module 140; and preserve finite onboard resources during altitude adjustments executed in response to hazardous local atmospheric conditions. Additionally, the aerial vehicle 110 can increase robustness of altitude control during extended flight durations, maintain hazard awareness during dynamic atmospheric conditions, and extend mission duration by minimizing unnecessary resource expenditure.

### 7.2 Local Controls: Autonomous Trigger Definition and Hazard Response

In one variation, Blocks of the method S100 recite, at the aerial vehicle 110: deriving a set of hazardous atmospheric conditions for indicating hazardous local atmospheric conditions within the sequence of altitude bands in Block S176; and detecting a hazardous atmospheric condition proximal the aerial vehicle 110 in response to an atmospheric condition, detected proximal the aerial vehicle 110, satisfying a hazardous atmospheric condition in the set of hazardous atmospheric conditions in Block S178.

In this variation, the remote computer system 150 can transmit a sequence of altitude bands to the aerial vehicle 110 that omit corresponding hazardous atmospheric conditions or alternative minimum (or maximum) altitudes for these altitude bands. In this implementation, the aerial vehicle 110 can implement onboard hazard-interpretation logic, such as to calibrate hazard-response sensitivity, adapt trigger thresholds to atmospheric uncertainty, and maintain hazard awareness without requiring explicit hazard-response instructions from the remote computer system 150. In particular, in this implementation, the aerial vehicle 110 can: access an altitude band for navigation during a time window; and, in response to absence of hazardous atmospheric conditions in the altitude band, derive a set of hazardous atmospheric conditions for indicating hazardous local atmospheric conditions within the altitude band.

In another variation, the aerial vehicle 110 can: access a bandwidth associated with the altitude band; interpret the bandwidth as implicitly encoding a confidence score or a risk score predicted for the altitude band based on the weather forecast; and derive the set of hazardous atmospheric conditions such that the value ranges of the hazardous atmospheric conditions are proportional to the bandwidth. For example, a narrow bandwidth can indicate a relatively high forecast confidence and/or relatively high risk to the aerial vehicle 110 (e.g., intersection with an icing-risk zone), such that the aerial vehicle 110 derives relatively smaller trigger thresholds (e.g., a minimum temperature of 0° C., a maximum humidity of 92%, or a vertical-velocity anomaly threshold of 3.5 m/s). Conversely, a wide bandwidth can indicate a relatively low forecast confidence or relatively low risk to the aerial vehicle 110 (e.g., traversal of a low-risk atmospheric region), such that the aerial vehicle 110 derives relatively larger trigger thresholds (e.g., −1° C., 97% humidity, or 5.0 m/s vertical-velocity anomaly) to maintain conservative hazard-response sensitivity during navigation of the altitude band. Thus, the aerial vehicle 110 can interpret the bandwidth as implicitly encoding forecast certainty or atmospheric-risk level and derive the set of hazardous atmospheric conditions accordingly.

The aerial vehicle 110 can then: access a set of signals output by the suite of sensors 160, while navigating the altitude band, that represent atmospheric conditions (e.g., temperature, humidity, pressure) proximal the aerial vehicle 110; detect a hazardous atmospheric condition proximal the aerial vehicle 110 in response to an atmospheric condition, represented in the set of signals, satisfying a hazardous atmospheric condition in the set of hazardous atmospheric conditions; and execute an alternative minimum (or maximum) altitude in response to detecting the hazardous atmospheric condition.

In one implementation, in response to absence of an alternative minimum (or maximum) altitude specified for the altitude band, the aerial vehicle 110 can: define a maneuver, such as descent toward the absolute minimum altitude or an ascent toward the absolute maximum altitude of the altitude band, predicted to decrease exposure to the hazardous atmospheric condition; and select an altitude-control type (e.g., venting lifting gas, implementing a sail module 140), such as based on available onboard resources (e.g., a remaining volume of lifting gas onboard the aerial vehicle 110). The aerial vehicle 110 can then implement methods and techniques described above to execute an altitude maneuver via: venting lifting gas from an inflatable element 120 of the aerial vehicle 110; releasing ballast material from a ballast module 130 arranged in the aerial vehicle 110; or actuating a control surface 142 arranged on a sail module 140 suspended below an inflatable element 120 of the aerial vehicle 110 to generate aerodynamic lift for altitude adjustment without consuming ballast material.

In one example, the aerial vehicle 110 can: derive a hazardous atmospheric condition specifying a minimum temperature (e.g., 0° C.) for the altitude band; access a signal output by a temperature sensor arranged on the aerial vehicle 110 while navigating the altitude band, the signal representing a temperature proximal the aerial vehicle 110; and, in response to the temperature falling below the minimum temperature, detect a hazardous atmospheric condition (e.g., an icing-risk condition) proximal the aerial vehicle 110. In response to detecting the hazardous atmospheric condition, the aerial vehicle 110 can then: calculate a volume of lifting gas to release from the inflatable element 120 of the aerial vehicle 110 to decrease altitude of the aerial vehicle 110 toward a target altitude predicted to exhibit an ambient temperature exceeding the minimum temperature; and actuate the lifting gas valve 122, coupled to the inflatable element 120, to release the volume of lifting gas from the inflatable element 120.

Accordingly, the remote computer system 150 can delegate hazard-interpretation logic to the aerial vehicle 110 when explicit hazardous atmospheric conditions and alternative minimum (or maximum) altitudes are unavailable. Therefore, the aerial vehicle 110 can: autonomously calibrate hazard-response sensitivity, such as based on bandwidth; autonomously maintain hazard awareness during dynamic atmospheric conditions; and reduce reliance on continuous uplink bandwidth when the remote computer system 150 provides only generic altitude-band instructions.

### 7.3 Hybrid Local Controls: Encoded and Autonomous Hazard Response

In one variation, the remote computer system 150 can transmit an altitude band (or a sequence of altitude bands) that incorporates both explicit hazard-response instructions and generic altitude-band specifications for future time windows. For example, the remote computer system 150 can define explicit hazardous atmospheric conditions and alternative minimum (or maximum) altitudes for altitude bands predicted to occur in near-term time windows or altitude bands characterized by relatively high forecast confidence (e.g., relatively high reliability or relatively stable hazard prediction). Conversely, the remote computer system 150 can omit corresponding hazardous atmospheric conditions and alternative minimum (or maximum) altitudes for altitude bands predicted to occur in later time windows, altitude bands characterized by relatively low forecast confidence, or altitude bands intersecting connectivity-risk regions in which predicted probability of satellite uplink loss exceeds a threshold (e.g., 0.80). In these examples, the remote computer system 150 can transmit the altitude band, such that the aerial vehicle 110 autonomously interprets hazards during navigation of the altitude band.

In particular, in this implementation, the aerial vehicle 110 can access an altitude band (or a sequence of altitude bands) for the aerial vehicle 110 to navigate, the altitude band specifying: a first altitude band for the aerial vehicle 110 to navigate during a first time window and a first hazardous atmospheric condition indicating presence of a first hazardous atmospheric condition within the first altitude band; and a second altitude band for the aerial vehicle 110 to navigate during a second time window succeeding the first time window (i.e., omitting a corresponding hazardous atmospheric condition and alternative minimum (or maximum) altitude). During the first time window, the aerial vehicle 110 can then: access a first set of signals output by a suite of sensors 160 arranged on the aerial vehicle 110 while navigating the first altitude band; detect the first hazardous atmospheric condition based on the first set of signals; and, in response to detecting the first hazardous atmospheric condition, execute a first alternative minimum (or maximum) altitude to avoid the first hazardous atmospheric condition.

Additionally, during the second time window, the aerial vehicle 110 can: access a second set of signals output by the suite of sensors 160 while navigating the second altitude band; derive a set of hazardous atmospheric conditions for indicating hazardous local atmospheric conditions within the second altitude band, such as based on a bandwidth associated with the second altitude band; detect a second hazardous atmospheric condition proximal the aerial vehicle 110 in response to an atmospheric condition satisfying a hazardous atmospheric condition in the derived set of hazardous atmospheric conditions; and, in response to detecting the second hazardous atmospheric condition, execute an altitude maneuver to avoid the second hazardous atmospheric condition.

Thus, the remote computer system 150 can: define explicit hazard-response instructions for altitude bands predicted to exhibit stable forecast characteristics; define generic altitude-band specifications for altitude bands predicted to exhibit higher atmospheric uncertainty or reduced forecast reliability; and delegate hazard-response actions to the aerial vehicle 110 when forecast uncertainty or connectivity-risk level exceeds a threshold.

### 8. Variation: Navigation Through Hazardous-Risk Zone

In one variation, as shown in FIGS. 3A and 3B, Blocks of the method S100 recite, at the remote computer system 150: predicting a hazardous-risk zone proximal the oscillating flight path of the aerial vehicle 110 during a time window, the hazardous-risk zone exhibiting an estimated maximum (or minimum) altitude in Block S112; estimating a minimum escape velocity for the aerial vehicle 110 to ascend through the hazardous-risk zone and above the estimated maximum altitude in Block S182; and transmitting the estimated maximum altitude and the minimum escape velocity to the aerial vehicle 110 in Block S150. In this variation, Blocks of the method S100 also recite, at the aerial vehicle 110: detecting a vertical ascent velocity of the aerial vehicle 110 while ascending toward the estimated maximum altitude during the time window in Block S122; and, in response to the vertical ascent velocity falling below the minimum escape velocity, triggering an actuator 134 in the aerial vehicle 110 to increase net buoyancy of the aerial vehicle 110 to increase the vertical ascent velocity toward the minimum escape velocity in Block S154.

In particular, in this variation, the remote computer system 150 can: estimate a minimum escape velocity for the aerial vehicle 110 to ascend (or descend) through a hazardous-risk zone based on an altitude range (e.g., between 5,000 feet and 6,000 feet) of the hazardous-risk zone and ambient conditions (e.g., temperature, humidity, dew point, icing-risk) within the hazardous-risk zone; and transmit this minimum escape velocity to the aerial vehicle 110.

In one example, the aerial vehicle 110 can: detect a vertical ascent velocity of the aerial vehicle 110 (e.g., via an onboard inertial sensor) while ascending toward the estimated maximum altitude during the time window; and selectively release ballast material or lifting gas based on the vertical ascent velocity. For example, in response to the vertical ascent velocity falling below the minimum escape velocity by less than a threshold (e.g., 20 m/s), the aerial vehicle 110 can trigger a ballast actuator 134 to actuate the ballast valve 132 to release ballast material to increase net buoyancy of the aerial vehicle 110 to increase the vertical ascent velocity toward the minimum escape velocity (i.e., to escape upward through the hazardous-risk zone). Alternatively, in response to the vertical ascent velocity falling below the minimum escape velocity by greater than the threshold, the aerial vehicle 110 can trigger a lifting gas actuator 124 to actuate the lifting gas valve 122 to release lifting gas to decrease net buoyancy of the aerial vehicle 110 to transition the aerial vehicle 110 from ascent to descent (i.e., to escape downward away from the hazardous-risk zone).

In another example, the aerial vehicle 110 can: detect a vertical descent velocity of the aerial vehicle 110 (e.g., via an onboard inertial sensor) while descending toward an estimated minimum altitude of the hazardous-risk zone during the time window; and selectively release ballast material or lifting gas based on the vertical ascent velocity. For example, in response to the vertical descent velocity falling below the minimum escape velocity by less than a threshold (e.g., 20 m/s), the aerial vehicle 110 can trigger the lifting gas actuator 124 to actuate the lifting gas valve 122 to release lifting gas and increase the vertical descent velocity toward the minimum escape velocity (i.e., to escape downward through the hazardous-risk zone). Alternatively, in response to the vertical descent velocity falling below the minimum escape velocity by greater than the threshold, the aerial vehicle 110 can trigger the ballast actuator 134 to actuate the ballast valve 132 to release ballast material to increase net buoyancy of the aerial vehicle 110 to transition the aerial vehicle 110 from descent to ascent (i.e., to escape upward away from the hazardous-risk zone).

### 9. Variation: Overflight of Tall Weather Systems

In one variation, as shown in FIGS. 3A and 3B, Blocks of the method S100 recite, at the remote computer system 150: estimating a lead time period until onset of a severe weather system proximal the aerial vehicle 110 in Block S180; and defining an oscillating flight path for the aerial vehicle 110, predicted to increase the current maximum vehicle altitude to greater than an estimated maximum altitude of the severe weather system, during the lead time period in Block S184.

In this variation, the remote computer system 150 can define an oscillating flight path for the aerial vehicle 110 to execute prior to onset of a tall or unavoidable weather system that is predicted to exceed a current ceiling altitude of the aerial vehicle 110. In particular, in this variation, the remote computer system 150 can access a weather forecast specifying a severe weather system: approaching the aerial vehicle 110; and exhibiting an estimated maximum system altitude (e.g., 18,000 meters). The remote computer system 150 can then: in response to the weather forecast specifying the severe weather system approaching the aerial vehicle 110, derive a population of trajectories (e.g., oscillating flight paths) for the aerial vehicle 110 to avoid the severe weather system based on forecasted wind vectors, projected storm motion, and an altitude band (or a sequence of altitude bands) currently assigned to the aerial vehicle 110. In response to the aerial vehicle 110 intersecting the severe weather system along each trajectory in the population of trajectories, the remote computer system 150 can: interpret unavoidability of the severe weather system; and access a current maximum vehicle altitude, such as a current altitude ceiling attainable by the aerial vehicle 110 based on current aerial vehicle mass, remaining ballast volume, remaining lifting-gas volume, and forecasted density-altitude conditions.

In response to the current maximum vehicle altitude (e.g., 17,000 meters) falling below the estimated maximum system altitude, the remote computer system 150 can then: estimate a lead time period (e.g., 36 hours) until onset of the severe weather system proximal the aerial vehicle 110; calculate a volume of ballast material (e.g., 480 grams) for the aerial vehicle 110 to release from the ballast module 130 to increase the current maximum vehicle altitude of the aerial vehicle 110 to greater than the estimated maximum system altitude of the severe weather system; calculate a cycle frequency (e.g., one cycle from the absolute minimum to absolute maximum altitude every 90 minutes) for the aerial vehicle 110 to yield a maximum quantity of altitude cycles within the altitude band while releasing the volume of ballast material during the lead time period; define an oscillating flight path characterized by this cycle frequency for navigation by the aerial vehicle 110; define an altitude band (or a sequence of altitude bands) that maintains the aerial vehicle 110 along this particular oscillating flight path; and transmit this altitude band (or a sequence of altitude bands) to the aerial vehicle 110. In one variation, the aerial vehicle 110 can further vent lifting gas during descent phases of altitude cycles to prevent over-pressurization of the inflatable element 112.

In this variation, the aerial vehicle 110 can execute this altitude-cycling maneuver to rapidly lighten the aerial vehicle 110 (i.e., to increase the maximum altitude attainable by the aerial vehicle 110) while maximizing data capture within the altitude band prior to onset of the severe weather system. More specifically, in response to predicting that the severe weather system exhibits a vertical extent that the aerial vehicle 110 cannot traverse at the current aerial vehicle mass, the remote computer system 150 can command aggressive altitude-cycling maneuvers to reduce total vehicle mass, raise the effective altitude ceiling, and enable the aerial vehicle 110 to overfly the severe weather system when the severe weather system intersects the aerial vehicle trajectory.

Furthermore, in this variation, the remote computer system 150 can: estimate a minimum escape velocity for the aerial vehicle 110 to ascend through the hazardous-risk zone; and transmit this estimated maximum altitude and the minimum escape velocity to the aerial vehicle 110. The aerial vehicle 110 can then implement methods and techniques described above to: detect a vertical ascent velocity of the aerial vehicle 110 (e.g., via an onboard inertial sensor) while ascending toward the estimated maximum altitude during the time window; and selectively release ballast material (i.e., to escape upward through the hazardous-risk zone) or vent lifting gas (i.e., to escape downward away from the hazardous-risk zone) based on the vertical ascent velocity.

Therefore, the remote computer system 150 can: interpret unavoidability of a severe weather system that exceeds the current altitude ceiling of the aerial vehicle 110; and command altitude-cycling maneuvers to increase the altitude ceiling prior to onset of the severe weather system while maximizing data capture. The aerial vehicle 110 can then selectively execute altitude maneuvers to ascend through the severe weather storm or redirect maneuver toward a lower, non-hazardous atmospheric region, such as when upward escape exhibits limited feasibility.

### 10. Variation: Detection of Weight-Inducing Condition

In one variation, as shown in FIG. 4, Blocks of the method S100 recite: accessing a temperature proximal the aerial vehicle 110 during a time window, a volume of ballast material released by the aerial vehicle 110 during the time window, and a real altitude change of the aerial vehicle 110 during the time window in Block S120; estimating an expected altitude change of the aerial vehicle 110 during the time window based on the volume of ballast material released by the aerial vehicle 110 in Block S136; and, in response to the temperature falling below a threshold temperature and in response to the real altitude change falling below the expected altitude change, interpreting a weight-inducing condition (e.g., ice accumulation) on the aerial vehicle 110 in Block S192.

In this variation, the remote computer system 150 can interpret ice accumulation on the aerial vehicle 110 based on discrepancies between expected vertical performance and realized vertical performance during the time window. In particular, the remote computer system 150 can: detect that the aerial vehicle 110 releases ballast material and climbs less than expected based on a predicted density-altitude profile; detect that the aerial vehicle 110 encounters temperatures predicted to induce ice formation; and interpret these conditions as indicating ice accumulation. The remote computer system 150 can then define a new altitude band for the aerial vehicle 110, such as to command descent toward an atmospheric region predicted to exhibit temperatures to melt accumulated ice (or condensation).

In one example, while the aerial vehicle 110 navigates a first altitude band during a first time window, the remote computer system 150 can access: a temperature encountered by the aerial vehicle 110 during the first time window; a volume of ballast material released by the aerial vehicle 110 during the first time window; and a real altitude change of the aerial vehicle 110 within the first altitude band during the first time window. The remote computer system 150 can then: estimate an expected altitude change of the aerial vehicle 110 during the first time window based on the volume of ballast material released by the aerial vehicle 110; and, in response to the real altitude change falling below the expected altitude change, interpret ice accumulation on the aerial vehicle 110. More specifically, the remote computer system 150 can interpret the discrepancy between expected and real altitude change as indicating increased vehicle mass attributable to ice accumulation, such as when a decrease in buoyant force is not predicted by the weather forecast. The remote computer system 150 can then identify an atmospheric region predicted to melt ice accumulation on the aerial vehicle 110, such as a warm layer located below the current altitude band and characterized by a temperature exceeding a threshold temperature. The remote computer system 150 can then define a new altitude band (e.g., located within this warm layer) for the aerial vehicle 110 to navigate during a subsequent time window.

Therefore, the remote computer system 150 can: detect ice accumulation based on discrepancies between altitude-change predictions and real altitude-change performance; command the aerial vehicle 110 to descend toward a warm atmospheric region predicted to melt accumulated ice; and prevent excessive mass increase on the aerial vehicle 110, reduced altitude ceiling, and structural risk (e.g., inflatable element burst conditions) associated with ice accumulation that may reduce flight duration and/or prematurely terminate the flight operation.

### 11. Variation: Intentional Mass Accumulation for Resource Conservation

In one variation, as shown in FIGS. 1A and 1B, the remote computer system 150 can command the aerial vehicle 110 to intentionally navigate toward an atmospheric region predicted to induce a weight-inducing condition (e.g., ice accumulation), such as to accumulate additional mass (e.g., in the form of water, vapor, or ice) predicted to induce passive descent of the aerial vehicle 110 without consuming lifting gas or ballast material. For example, the remote computer system 150 can command the aerial vehicle 110 to intentionally navigate toward an atmospheric region predicted to induce additional mass at the aerial vehicle 110, such as: to descend into a lower altitude band without permanent resource expenditure; to preserve onboard resources for later hazard-response maneuvers; and to extend mission duration by preserving lifting gas reserves that may otherwise be permanently vented during descent.

In one variation, while the aerial vehicle 110 navigates a particular altitude band, the remote computer system 150 can: access atmospheric data (e.g., humidity data, temperature data) captured by the suite of sensors 160 arranged on the aerial vehicle 110; and detect a weight-inducing atmospheric condition, such as an icing condition. In this variation, rather than commanding the aerial vehicle 110 to trigger a ballast module 130 and/or venting module to adjust altitude (and avoid this weight-inducing atmospheric condition), the remote computer system 150 can command the aerial vehicle 110 to maintain altitude toward the weight-inducing atmospheric condition to induce additional weight (e.g., in the form of water, vapor, ice) at the aerial vehicle 110 that passively decreases altitude of the aerial vehicle 110.

In one example, the remote computer system 150 can define a sequence of altitude bands including: a first altitude band for the aerial vehicle 110 to navigate during a first time window; and a second altitude band, located below the first altitude band, for the aerial vehicle 110 to navigate for the second time window. In particular, the remote computer system 150 can: identify an atmospheric zone exhibiting atmospheric conditions predicted to induce ice accumulation on the aerial vehicle 110; and define the first altitude band intersecting the atmospheric zone, such that the aerial vehicle 110 can accumulate ice (i.e., additional mass) while navigating the first altitude band and passively descend toward the second altitude band for the next time window.

For example, a local controller 170 at the aerial vehicle 110 can: access a temperature value from a temperature sensor arranged at the aerial vehicle 110 during increase in altitude of the aerial vehicle 110 toward an absolute maximum altitude of an altitude band; access a humidity value from a humidity sensor arranged at the aerial vehicle 110 during increase in altitude of the aerial vehicle 110 toward the ceiling of the altitude band; and, in response to the temperature value falling below a threshold temperature value (e.g., 0° C.) and the humidity value exceeding a threshold humidity value, detect an icing atmospheric condition proximal the ceiling of the altitude band. The aerial vehicle 110 can then maintain an altitude increase of the aerial vehicle 110 toward the icing atmospheric condition at the ceiling of the altitude band to induce an additional mass (e.g., five pounds of ice accumulation) at the aerial vehicle 110 to induce a passive altitude decrease of the aerial vehicle 110 below the icing atmospheric condition.

Additionally, in this variation, the aerial vehicle 110 can detect a hazardous atmospheric condition (e.g., a minimum temperature at a maximum humidity), such as a hazardous atmospheric condition predicted to yield condensation on an inflatable element 120 of the aerial vehicle 110. Furthermore, responsive to detection of the hazardous atmospheric condition, the aerial vehicle 110 can implement methods and techniques described above to execute an altitude maneuver (e.g., venting lifting gas, dropping ballast), such as to navigate to an atmospheric zone predicted to reduce condensation or melt ice accumulation on the inflatable element 120 of the aerial vehicle 110.

For example, the local controller 170 at the aerial vehicle 110 can: access a temperature value from a temperature sensor arranged at the aerial vehicle 110 during descent in altitude of the aerial vehicle 110 toward an absolute minimum altitude of an altitude band; access a humidity value from a humidity sensor arranged at the aerial vehicle 110 during decrease in altitude of the aerial vehicle 110 toward the absolute minimum altitude of the altitude band; and, in response to the temperature value exceeding a threshold temperature value (e.g., 32 degrees Fahrenheit) and the humidity value falling below a threshold humidity value, detect a warm atmospheric condition proximal the ceiling of the altitude band. The aerial vehicle 110 can then maintain this altitude decrease of the aerial vehicle 110 toward the warm atmospheric condition at the absolute minimum altitude of the altitude band to shed (or “melt) additional weight (e.g., five pounds) at the aerial vehicle 110 that automatically induces an altitude increase of the aerial vehicle 110 above the warm atmospheric condition. Therefore, the remote computer system 150 can leverage intentional exposure to atmospheric conditions for passive altitude control by: commanding exposure to icing conditions to accumulate mass for controlled passive descent (i.e., conserving lifting gas); and commanding exposure to warm conditions to melt accumulated ice for passive ascent (i.e., conserving ballast material).

### 12. Variation: High-value Data Collection During Terminal Flight Phase

In one variation, Block S188 of the method S100 recites estimating a remaining flight duration for the aerial vehicle 110 based on a volume of ballast material contained in the ballast module 130 and a volume of lifting gas contained in the inflatable element 120. In this variation, as shown in FIG. 2B, the remote computer system 150 can command a near-end-of-life aerial vehicle (e.g., containing limited onboard resources) to penetrate a severe weather system to collect high-value atmospheric data prior to flight termination. Thus, in this variation, the remote computer system 150 can accept a controlled increase in hazard exposure to the aerial vehicle 110 to maximize meteorological data capture prior to flight termination.

In particular, in this variation, the remote computer system 150 can: access a weather forecast for a particular time window that specifies a severe weather system (e.g., a tropical storm, a rapidly intensifying cyclone, or an over-ocean hurricane):
proximal or approaching the aerial vehicle 110; and characterized by a meteorological data value score exceeding a threshold score. More specifically, a relatively high meteorological data value score can indicate that: the severe weather system exhibits extreme atmospheric gradients (e.g., rapid changes in pressure, temperature, or humidity) predicted to contain relatively high information content; the severe weather system exhibits limited direct observational coverage (e.g., deep-ocean or polar-region storm tracks); or the severe weather system exhibits rapid development or intensification that demands high-resolution sampling.

The remote computer system 150 can then estimate a maximum remaining flight duration for the aerial vehicle 110 based on: a first volume of ballast material contained in a ballast module 130 arranged in the aerial vehicle 110; and a second volume of lifting gas contained in an inflatable element 120 of the aerial vehicle 110. In response to the meteorological data value score exceeding the threshold score and in response to the remaining flight duration falling below a threshold duration (e.g., 6 hours), the remote computer system 150 can: define a new altitude band, predicted to intersect the severe weather system, for the aerial vehicle 110 to navigate for the next time window to penetrate the severe weather system; and transmit the new altitude band to the aerial vehicle 110.

The aerial vehicle 110 can then implement methods and techniques described above to: receive the new altitude band transmitted by the remote computer system 150; navigate into the altitude band intersecting the severe weather system; collect atmospheric data (e.g., temperature, humidity, turbulence intensity, pressure gradients) within the altitude band; and transmit data captured by the suite of sensors 160 arranged on the aerial vehicle 110 to the remote computer system 150. Therefore, the remote computer system 150 can: classify the aerial vehicle 110 as near end-of-life based on remaining ballast material and lifting gas onboard the aerial vehicle 110; command intentional penetration of a severe weather system exhibiting a meteorological-data-value score exceeding a threshold score; and acquire high-value meteorological data during a terminal flight window.

### 13. Variation: Updating Weather Forecast+Altitude Bands

In one variation, the remote computer system 150 can: iteratively (e.g., hourly) receive (or “intercept”) real-time high-resolution atmospheric data from nearby aerial vehicles deployed in the atmosphere; and predict a new weather forecast based on the set of ambient data and a weather forecasting model configured to generate weather forecasts based on atmospheric data detected by the aerial vehicle 110. In this variation, the remote computer system 150 can detect differences between an initial weather forecast and the new weather forecast, such as: shifts in spatial extent of forecast hazardous zones; temporal acceleration or delay in the projected movement of a severe weather system; intensification or weakening of a hazardous-risk zone; or emergence of a new hazardous-risk zone. In one example, in response to the new weather forecast deviating from the initial weather forecast by greater than a threshold forecast difference (e.g., 12% spatial error across a five-hour projection window), the remote computer system 150 can implement methods and techniques described above to: define a new an altitude band (or a sequence of altitude bands) for the aerial vehicle 110 to navigate, such as to relocate the aerial vehicle 110 away from a newly formed hazardous-risk zone or toward a region exhibiting lower atmospheric risk; and transmit the new altitude band (or a sequence of altitude bands) to the aerial vehicle 110.

In one example, the remote computer system 150 can: read a sequence of relative humidity levels from a humidity sensor arranged on the aerial vehicle 110; detect an increase in humidity levels, in the sequence of relative humidity levels, exceeding a threshold humidity level (e.g., 90%); and identify this increase in humidity levels as the aerial vehicle 110 approaching a high-precipitation region in the atmosphere. The remote computer system 150 can then: interpret that the initial weather forecast underestimated precipitation intensity in the region; predict updated risk zone minimum and maximum altitudes for the high-precipitation region (i.e., a hazardous-risk zone); define a new altitude band located outside the high-precipitation region; and transmit the new altitude band to the aerial vehicle 110 for navigation during the subsequent time window.

The aerial vehicle 110 can then: receive the new altitude band; and execute closed-loop controls to adjust altitude of the aerial vehicle 110 within the new altitude band and maintain the aerial vehicle 110 along the updated flight path. Furthermore, the remote computer system 150 can then: repeat this process (e.g., hourly, bi-hourly) during a flight operation of an aerial vehicle 110 (or multiple aerial vehicles) deployed in the atmosphere; implement this high-resolution atmospheric data to validate and/or calibrate predicted atmospheric data from the weather forecast; and selectively update the oscillating flight path for the aerial vehicle 110 (or multiple aerial vehicles). Therefore, the remote computer system 150 can access real-time high-resolution onboard atmospheric data from the aerial vehicle 110 to forecast an updated altitude band that avoids anomalous atmospheric conditions forming proximal the aerial vehicle 110.

### 14. Variation: Recovering Oscillating Flight Path

In one variation, while the aerial vehicle 110 executes an altitude maneuver (e.g., to avoid a hazardous atmospheric zone), the aerial vehicle 110 can: access a current position, different from a target position, of the aerial vehicle 110 at a current time; retrieve a target altitude band, in the sequence of altitude bands, assigned to the aerial vehicle 110 at the current time; and execute closed-loop controls to maneuver the aerial vehicle 110 into the target altitude band. For example, the aerial vehicle 110 can: based on the current position of the aerial vehicle 110, calculate a ballast release volume and/or a lifting gas volume predicted to maneuver the aerial vehicle 110 to the target altitude band; and release the ballast release volume or the lifting gas volume to maneuver the aerial vehicle 110 into the target altitude band.

In another variation, the remote computer system 150 can implement methods and techniques described above to generate a new flight path and/or recalculate the flight path after the aerial vehicle 110 deviates from a current flight path by more than a threshold distance and/or given a new weather forecast generated in light of new onboard weather data from the aerial vehicle 110, weather data retrieved from updated global weather forecasts, and/or weather data retrieved from other deployed aerial vehicles. Therefore, the aerial vehicle 110 can: maintain contextual awareness of anomalous hazardous atmospheric zones not represented in the initial weather forecast; and execute local closed-loop controls to avoid these anomalous hazardous atmospheric zones.

### 15. Variation: Stalling Condition

In one variation, while traversing proximal the oscillating flight path, the aerial vehicle 110 can: detect a stall condition (e.g., a null descent/ascent rate) of the aerial vehicle 110 within the sequence of altitude bands; and, in response to detecting the stall condition, the aerial vehicle 110 can then execute closed-loop controls to resolve the stall condition of the aerial vehicle 110. For example, the aerial vehicle 110 can: trigger a venting module to vent a lifting gas; and/or trigger a ballast module 130 to drop ballast media to induce a non-zero ascent/descent rate of the aerial vehicle 110 along the oscillating flight path. The aerial vehicle 110 can then implement methods and techniques described above to maneuver the aerial vehicle 110 into a new target altitude band along the oscillating flight path. Therefore, the aerial vehicle 110 can: detect deviation of the aerial vehicle 110 from the oscillating flight path; and execute closed-loop controls to induce positive and/or negative lift to maintain the aerial vehicle 110 along the oscillating flight path.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
at a remote computer system:
at a first time:
receiving an initial geospatial location of an aerial vehicle, traversing an oscillating flight path, at an initial time preceding the first time; and
receiving an initial set of ambient data, recorded over an initial time window preceding the first time, from the aerial vehicle;
updating a first weather forecast for a first forecast window succeeding the first time based on the initial set of ambient data;
based on the first weather forecast:
predicting a first hazardous-risk zone, proximal the oscillating flight path of the aerial vehicle, during the first forecast window;
defining a first altitude band constraining the oscillating flight path of the aerial vehicle during a first time window succeeding the initial time window, the first altitude band defining:
a first absolute minimum altitude intersecting the first hazardous-risk zone; and
a first absolute maximum altitude; and
defining a first alternative minimum altitude, between the first absolute minimum altitude and the first absolute maximum altitude, proximal a first boundary of the first hazardous-risk zone for the first time window; and
transmitting the first altitude band and the first alternative minimum altitude to the aerial vehicle; and
at the aerial vehicle:
accessing a first set of signals output by a suite of sensors arranged on the aerial vehicle while descending toward the first alternative minimum altitude during the first time window;
based on the first set of signals, detecting a first hazardous atmospheric condition proximal the aerial vehicle; and
in response to detecting the first hazardous atmospheric condition following descent of the aerial vehicle below the first alternative minimum altitude:
triggering a first actuator in the aerial vehicle to increase net buoyancy of the aerial vehicle to transition the aerial vehicle from descent to ascent.

2. The method of claim 1, wherein triggering the first actuator in the aerial vehicle to increase net buoyancy of the aerial vehicle comprises, at the aerial vehicle:
triggering the first actuator to actuate a ballast valve, coupled to a ballast module arranged in the aerial vehicle, to release ballast material, contained in the ballast module, to transition the aerial vehicle from descent to ascent.

3. The method of claim 1, further comprising:
at the aerial vehicle:
recording a first set of ambient data, representing local atmospheric conditions proximal the aerial vehicle, while navigating the first altitude band during the first time window; and
in response to conclusion of the first time window, transmitting the first set of ambient data to the remote computer system; and
at the remote computer system:
based on a second weather forecast for a second time window succeeding the first time window:
predicting a second hazardous-risk zone, proximal the oscillating flight path of the aerial vehicle, during the second time window;
defining a second altitude band constraining the oscillating flight path of the aerial vehicle during the second time window; and
defining a second alternative maximum altitude, within the second altitude band, proximal a second boundary of the second hazardous-risk zone for the second time window; and
transmitting the second altitude band and the second alternative maximum altitude to the aerial vehicle.

4. The method of claim 3, further comprising, at the aerial vehicle:
accessing a second set of signals output by the suite of sensors while ascending toward the second alternative maximum altitude during the second time window;
based on the second set of signals, detecting a second hazardous atmospheric condition proximal the aerial vehicle; and
in response to detecting the second hazardous atmospheric condition following ascent of the aerial vehicle above the second alternative maximum altitude:
triggering a second actuator in the aerial vehicle to decrease net buoyancy of the aerial vehicle to transition the aerial vehicle from ascent to descent.

5. The method of claim 4:
wherein predicting the first hazardous-risk zone comprises, at the remote computer system, predicting the first hazardous-risk zone exhibiting atmospheric turbulence;
wherein detecting the first hazardous atmospheric condition comprises, at the aerial vehicle, detecting the first hazardous atmospheric condition based on a first signal output by an inertial sensor and representing a vertical acceleration of the aerial vehicle exceeding a threshold acceleration;
wherein triggering the first actuator in the aerial vehicle to increase net buoyancy of the aerial vehicle comprises, at the aerial vehicle, triggering the first actuator to actuate a ballast valve, coupled to a ballast module arranged in the aerial vehicle, to release ballast material contained in the ballast module;
wherein predicting the second hazardous-risk zone comprises, at the remote computer system, predicting the second hazardous-risk zone exhibiting temperatures predicted to yield ice accumulation on the aerial vehicle;
wherein detecting the second hazardous atmospheric condition comprises, at the aerial vehicle, detecting the second hazardous atmospheric condition in response to detecting a real deceleration of the aerial vehicle falling below an expected deceleration of the aerial vehicle during the second time window; and
wherein triggering the second actuator in the aerial vehicle to decrease net buoyancy of the aerial vehicle comprises, at the aerial vehicle, triggering the second actuator to actuate a lifting gas valve, coupled to an inflatable element of the aerial vehicle, to release lifting gas, contained in the inflatable element.

6. The method of claim 1:
wherein predicting the first hazardous-risk zone comprises, at the remote computer system, predicting the first hazardous-risk zone during the first time window;
wherein defining the first alternative minimum altitude for the first time window comprises, at the remote computer system, defining the first alternative minimum altitude based on presence of the first hazardous-risk zone during the first time window; and
further comprising:
at the remote computer system:
predicting a second hazardous-risk zone, proximal the oscillating flight path of the aerial vehicle, during a second time window succeeding the first time window based on a second weather forecast for the second time window;
defining a second altitude band constraining the oscillating flight path of the aerial vehicle during the second time window based on presence of the second hazardous-risk zone during the second time window;
defining a second alternative minimum altitude, within the second altitude band, based on presence of the second hazardous-risk zone during the second time window; and
transmitting the second altitude band and the second alternative minimum altitude to the aerial vehicle; and
at the aerial vehicle:
during the second time window:
in response to absence of receipt of a third altitude band defined by the remote computer system for the second time window, navigating the second altitude band.

7. The method of claim 1:
wherein predicting the first hazardous-risk zone comprises, at the remote computer system, predicting the first hazardous-risk zone during the first time window;
wherein defining the first altitude band comprises, at the remote computer system:
defining the oscillating flight path comprising a sequence of waypoints; and
defining the first altitude band spanning a first narrow altitude range intersecting a first waypoint, in the sequence of waypoints, during the first time window;
wherein defining the first alternative minimum altitude for the first time window
comprises, at the remote computer system, defining the first alternative minimum altitude for the aerial vehicle to avoid the first hazardous atmospheric condition during the first time window; and
further comprising:
at the remote computer system:
defining a second altitude band:
constraining the oscillating flight path of the aerial vehicle during a second time window succeeding the first time window; and
spanning a second narrow altitude range, different from the first narrow altitude range, intersecting a second waypoint, in the sequence of waypoints, during the second time window; and
transmitting the second altitude band to the aerial vehicle; and
at the aerial vehicle:
during the second time window:
in response to absence of receipt of a third altitude band defined by the remote computer system for the second time window, navigating the second altitude band.

8. The method of claim 1:
further comprising, at the remote computer system, defining the first hazardous atmospheric condition specifying a combination of ambient temperature and ambient humidity predicted to yield condensation on an inflatable element of the aerial vehicle; and
wherein detecting the first hazardous atmospheric condition comprises, at the aerial vehicle, detecting the first hazardous atmospheric condition based on a temperature signal output by a temperature sensor and representing a first temperature proximal
the aerial vehicle and a humidity signal output by a humidity sensor and representing a first humidity proximal the aerial vehicle, the first temperature and the first humidity predicted to yield condensation on the inflatable element.

9. The method of claim 1:
wherein defining the first altitude band comprises, at the remote computer system:
defining the first absolute minimum altitude of the first altitude band:
defining a target altitude for the aerial vehicle to approach to collect ambient data from the first hazardous-risk zone; and
constraining the oscillating flight path of the aerial vehicle above a region of the first hazardous-risk zone predicted to terminate operation of the aerial vehicle; and
wherein defining the first alternative minimum altitude comprises, at the remote computer system:
defining the first alternative minimum altitude:
located above the first hazardous-risk zone; and
defining an alternative altitude for the aerial vehicle to descend below prior to transitioning from descent to ascent.

10. The method of claim 9:
further comprising, at the remote computer system, estimating a remaining flight duration for the aerial vehicle based on:
a first volume of ballast material contained in a ballast module arranged in the aerial vehicle; and
a second volume of lifting gas contained in an inflatable element of the aerial vehicle; and
wherein defining the first alternative minimum altitude comprises, at the remote computer system:
defining the first alternative minimum altitude:
located above the first absolute minimum altitude by an offset distance
proportional to the remaining flight duration.

11. The method of claim 1, wherein updating the first weather forecast for the first forecast window comprises:
accessing an initial weather forecast, constructed based on a population of ambient data collected by a population of aerial vehicles, for the initial time window;
projecting the initial set of ambient data into the initial weather forecast; and
extrapolating the first weather forecast from the initial weather forecast based on the initial set of ambient data.

12. The method of claim 1, further comprising:
at the remote computer system:
receiving a first set of ambient data, recorded over the first time window, from the aerial vehicle;
updating a second weather forecast for a second forecast window succeeding the first forecast window based on the first set of ambient data;
based on the second weather forecast:
predicting a second hazardous-risk zone:
proximal the oscillating flight path of the aerial vehicle during a second time window; and
exhibiting an estimated maximum altitude;
estimating a minimum escape velocity for the aerial vehicle to ascend through the second hazardous-risk zone and above the estimated maximum altitude; and
transmitting the estimated maximum altitude and the minimum escape velocity to the aerial vehicle; and
at the aerial vehicle:
detecting a vertical ascent velocity of the aerial vehicle while ascending toward the estimated maximum altitude during the second time window;
in response to the vertical ascent velocity falling below the minimum escape velocity by less than a threshold:
triggering the first actuator in the aerial vehicle to increase net buoyancy of the aerial vehicle and increase the vertical ascent velocity toward the minimum escape velocity; and
in response to the vertical ascent velocity falling below the minimum escape velocity by greater than the threshold:
triggering a second actuator in the aerial vehicle to decrease net buoyancy of the aerial vehicle to transition the aerial vehicle from ascent to descent.

13. A method comprising:
at a remote computer system:
receiving an initial set of ambient data, recorded over an initial time window, from an aerial vehicle, traversing an oscillating flight path, at a first time;
updating a first weather forecast for a first forecast window succeeding the initial time window based on the initial set of ambient data;
based on the first weather forecast:
predicting a first hazardous-risk zone, proximal the oscillating flight path of the aerial vehicle, during the first forecast window;
defining a first altitude band constraining the oscillating flight path of the aerial vehicle during a first time window succeeding the initial time window, the first altitude band defining:
a first absolute minimum altitude; and
a first absolute maximum altitude intersecting the first hazardous-risk zone; and
defining a first alternative maximum altitude, between the first absolute minimum altitude and the first absolute maximum altitude, proximal a first boundary of the first hazardous-risk zone for the first time window; and
transmitting the first altitude band and the first alternative maximum altitude to the aerial vehicle; and
at the aerial vehicle:
detecting a first hazardous atmospheric condition proximal the aerial vehicle while ascending toward the first alternative maximum altitude during the first time window; and
in response to detecting the first hazardous atmospheric condition following ascent of the aerial vehicle above the first alternative maximum altitude:
triggering an actuator in the aerial vehicle to decrease net buoyancy of the aerial vehicle to transition the aerial vehicle from ascent to descent.

14. The method of claim 13:
wherein defining the first altitude band comprises, at the remote computer system:
defining the first absolute maximum altitude of the first altitude band:
defining a target altitude for the aerial vehicle to approach to collect ambient data proximal the first hazardous-risk zone; and
constraining the oscillating flight path of the aerial vehicle below a region of the first hazardous-risk zone predicted to terminate operation of the aerial vehicle; and
wherein defining the first alternative maximum altitude for the first time window comprises, at the remote computer system:
defining the first alternative maximum altitude:
located below the first hazardous-risk zone; and
defining an alternative altitude for the aerial vehicle to ascend above prior to transitioning from ascent to descent.

15. The method of claim 13, further comprising:
at the remote computer system:
updating a second weather forecast for a second forecast window, succeeding the first time window, based on a first set of ambient data recorded over the first time window by the aerial vehicle;
based on the second weather forecast:
predicting a second hazardous-risk zone:
proximal the oscillating flight path of the aerial vehicle during a second time window; and
exhibiting an estimated minimum altitude;
estimating a minimum escape velocity for the aerial vehicle to descend through the second hazardous-risk zone and below the estimated minimum altitude; and
transmitting the estimated minimum altitude and the minimum escape velocity to the aerial vehicle; and
at the aerial vehicle:
detecting a vertical descent velocity of the aerial vehicle while descending toward the estimated minimum altitude during the second time window; and
in response to the vertical descent velocity falling below the minimum escape velocity:
triggering the actuator in the aerial vehicle to decrease net buoyancy of the aerial vehicle to increase the vertical descent velocity toward the minimum escape velocity.

16. The method of claim 13:
further comprising, at the remote computer system:
defining the first hazardous atmospheric condition specifying an expected deceleration of the aerial vehicle while ascending toward the first alternative maximum altitude during the first time window; and
wherein detecting the first hazardous atmospheric condition comprises, at the aerial vehicle:
accessing a first signal output by an inertial sensor and representing a real deceleration of the aerial vehicle, falling below the expected deceleration, following ascent of the aerial vehicle above the first alternative maximum altitude; and
detecting the first hazardous atmospheric condition in response to real deceleration of the aerial vehicle falling below the expected deceleration.

17. A method comprising:
at a remote computer system:
accessing a first weather forecast for a first forecast window;
based on the first weather forecast:
predicting a constellation of hazardous-risk zones comprising a first hazardous-risk zone:
proximal an oscillating flight path of an aerial vehicle during a first time window; and
exhibiting an estimated maximum altitude; and
defining a sequence of altitude bands for navigation by the aerial vehicle, the sequence of altitude bands:
predicted to maximize atmospheric data capture by the aerial vehicle; and
comprising a first altitude band constraining the oscillating flight path of the aerial vehicle during the first time window, the first altitude band defining:
a first absolute minimum altitude intersecting the first hazardous-risk zone; and
a first absolute maximum altitude; and
transmitting the estimated maximum altitude and the sequence of altitude bands to the aerial vehicle; and
at the aerial vehicle:
receiving the estimated maximum altitude and the sequence of altitude bands from the remote computer system; and
navigating the first altitude band during the first time window.

18. The method of claim 17:
wherein accessing the first weather forecast for the first forecast window comprises:
receiving a first set of ambient data collected by the aerial vehicle during an initial time window preceding the first forecast window; and
updating an initial weather forecast based on the first set of ambient data; and
further comprising:
at the remote computer system:
estimating a minimum escape velocity for the aerial vehicle to ascend through the first hazardous-risk zone and above the estimated maximum altitude; and
transmitting the minimum escape velocity to the aerial vehicle; and
at the aerial vehicle:
while ascending toward the estimated maximum altitude during the first time window:
detecting a first hazardous atmospheric condition proximal the aerial vehicle; and
detecting a first vertical ascent velocity of the aerial vehicle; and
in response to detecting the first hazardous atmospheric condition and in response to the first vertical ascent velocity falling below the minimum escape velocity:
triggering a first actuator in the aerial vehicle to decrease net buoyancy of the aerial vehicle to transition the aerial vehicle from ascent to descent.

19. The method of claim 18:
further comprising, at the remote computer system:
based on the first weather forecast, defining a first alternative maximum altitude, between the first absolute minimum altitude and the first absolute maximum altitude, proximal a first boundary of the first hazardous-risk zone for the first time window; and
wherein triggering the first actuator in the aerial vehicle to decrease net buoyancy of the aerial vehicle comprises, at the aerial vehicle:
in response to detecting the first hazardous atmospheric condition and in response to the first vertical ascent velocity falling below the minimum escape velocity following ascent of the aerial vehicle above the first alternative maximum altitude:
triggering the first actuator in the aerial vehicle to decrease net buoyancy of the aerial vehicle to transition the aerial vehicle from ascent to descent.

20. The method of claim 17:
further comprising, at the remote computer system:
estimating a minimum escape velocity for the aerial vehicle to ascend through the first hazardous-risk zone and above the estimated maximum altitude; and
transmitting the minimum escape velocity to the aerial vehicle; and
wherein predicting the constellation of hazardous-risk zones comprises, at the remote computer system:
predicting the first hazardous-risk zone exhibiting a first combination of ambient temperature and ambient humidity predicted to yield condensation on an inflatable element of the aerial vehicle;
further comprising, at the aerial vehicle:
while ascending toward the estimated maximum altitude during the first time window:
detecting a first hazardous atmospheric condition, proximal the aerial vehicle, based on a signal output by a temperature sensor and representing a temperature of the inflatable element predicted to yield condensation; and
detecting a first vertical ascent velocity of the aerial vehicle; and
in response to detecting the first hazardous atmospheric condition and in response to the first vertical ascent velocity falling below the minimum escape velocity:
triggering a first actuator in the aerial vehicle to decrease net buoyancy of the aerial vehicle to descend toward a second atmospheric zone exhibiting a second combination of ambient temperature and ambient humidity predicted to reduce condensation on the inflatable element.
